(19) United States
(12) Patent Application Publication
(10) Pub. No.: US 2025/0008472 A1
(43) Pub. Date: Jan. 2, 2025

(54) GROUP DELAY ERROR MITIGATION IN FULL DUPLEX MODES

(71) Applicant: QUALCOMM Incorporated, San Diego, CA (US)

(72) Inventors: Weimin DUAN, San Diego, CA (US); Alexandros MANOLAKOS, Athens (GR); Muhammad Sayed Khairy ABDELGHAFFAR, San Jose, CA (US); Ahmed Attia ABOTABL, San Diego, CA (US)

(21) Appl. No.: 18/699,949

(22) PCT Filed: Nov. 9, 2022
(86) PCT No.: PCT/US2022/049393

§ 371 Date: Apr. 10, 2024

(30) Foreign Application Priority Data
Dec. 13, 2021 (GR) 20210100872

(51) Int. Cl. H04W 64/00; H04L 5/00; H04L 5/16; H04W 76/20

(52) U.S. Cl. CPC H04W 64/00; H04L 5/0051; H04L 5/16; H04W 76/20

(57) ABSTRACT

Techniques are provided for mitigating group delay errors across half duplex and full duplex operations. An example method of performing a round trip time message exchange includes performing the round trip time message exchange with a wireless node including receiving a downlink positioning reference signal and transmitting an uplink positioning reference signal, wherein the round trip time message exchange is associated with at least one duplex mode, and reporting a receive-transmit time difference measurement value based on the round trip time message exchange, wherein the reporting includes an indication of the at least one duplex mode.

### CROSS-REFERENCE TO RELATED APPLICATION

This application claims the benefit of Greek patent application No. 20210100872, filed Dec. 13, 2021, entitled “GROUP DELAY ERROR MITIGATION IN FULL DUPLEX MODES,” which is assigned to the assignee hereof, and the entire contents of which are hereby incorporated herein by reference for all purposes.

### BACKGROUND

### Field of the Disclosure

Aspects of the present disclosure relate to wireless communications, and more particularly, to techniques for user equipment(s) to utilize positioning reference signal with half and full duplex operations.

### Description of Related Art

Wireless communication systems are widely deployed to provide various telecommunication services such as telephony, video, data, messaging, broadcasts, positioning, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Fifth Generation New Radio systems (5G NR), Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

Obtaining the location or position of a mobile device that is accessing a wireless communication system may be useful for many applications including, for example, emergency calls, personal navigation, asset tracking, locating a friend or family member, etc. Existing position methods include methods based on measuring radio signals transmitted from a variety of devices including satellite vehicles (SVs) and terrestrial radio sources in a wireless network such as base stations and access points. In methods based on terrestrial radio sources, a mobile device may measure the timing of signals received from two or more base stations and determine times of arrival, time differences of arrival and/or receive time-transmit time differences. Combining these measurements with known locations for the base stations and known transmission times from each base station may enable location of the mobile device using such position methods as Observed Time Difference Of Arrival (OTDOA) or Enhanced Cell ID (ECID).

To further help location determination (e.g. for OTDOA), Positioning Reference Signals (PRS) may be transmitted by base stations in order to increase both measurement accuracy and the number of different base stations for which timing measurements can be obtained by a mobile device. In general, the base stations and mobile devices may communicate using half duplex operation which sequentially utilize either downlink channels (e.g., for transmissions from a base station to a mobile device) or uplink channels (e.g., for transmissions from a mobile device to a base station). Emerging technologies, however, will enable full duplex operations in which a base station or mobile device may communicate on downlink and uplink channels simultaneously. Combinations of half and full duplex operations may impact the efficiency of terrestrial positioning processes.

### SUMMARY

An example method for providing positioning reference signal measurement values according to the disclosure includes receiving assistance data including configuration information for downlink and uplink positioning reference signals, determining timing information for the downlink and the uplink positioning reference signals relative to a first period associated with a half duplex mode and a second period associated with a full duplex mode, performing a uplink positioning reference signal round trip time message exchange with a wireless node in either the first period or the second period, wherein a downlink positioning reference signal is received and an uplink positioning reference signal is transmitted during a selected period, and reporting one or more positioning reference signal measurement values and an indication of an associated duplex mode.

An example method of performing a round trip time message exchange according to the disclosure includes performing the round trip time message exchange with a wireless node including receiving a downlink positioning reference signal and transmitting an uplink positioning reference signal, wherein the round trip time message exchange is associated with at least one duplex mode, and reporting a receive-transmit time difference measurement value based on the round trip time message exchange, wherein the reporting includes an indication of the at least one duplex mode.

An example method of determining a position estimate of a wireless node according to the disclosure includes receiving a plurality of positioning reference signal measurement values from the wireless node, determining duplex mode information associated with each of the plurality of positioning reference signal measurement values, selecting a subset of the plurality of positioning reference signal measurement values based at least in part on the duplex mode information, and determining the position estimate for the wireless node based at least in part on the subset of the plurality of positioning reference signal measurement values.

Items and/or techniques described herein may provide one or more of the following capabilities, as well as other capabilities not mentioned. A wireless node such as user equipment, reference nodes, and base stations may be configured to operation in half duplex and full duplex modes. Reference signals such as downlink positioning reference signals and uplink sounding reference signals may be transmitted and received in different duplex modes. Different duplex modes may have different group error delays because different radio frequency transmit and receive chains may be used. The impact of group errors associated with transmitting and receiving positioning reference signals may be mitigated when reference signals are transmitted and received in predetermined duplex modes. Differential round trip time methods may be used to determine group errors associated with the different duplex modes. The accuracy of reference signal position estimates may be improved. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a block diagram conceptually illustrating an example telecommunications system.

FIG. 2 is a block diagram illustrating an example architecture of a distributed radio access network (RAN), in accordance with certain aspects of the present disclosure.

FIGS. 3A-3C illustrate different full duplex communication modes in a telecommunication system.

FIGS. 4A & 4B show examples of different types of full duplex operation.

FIGS. 5 and 6 are diagrams illustrating exemplary techniques for determining a position of a mobile device using information obtained from a plurality of base stations.

FIG. 7A is an example round trip message flow between a user equipment and a base station.

FIG. 7B is a message flow diagram of example impacts of group delay errors within wireless transceivers.

FIG. 8 illustrates an example spectrum for a full duplex base station and half duplex mobile devices.

FIG. 9 illustrates an example spectrum for a full duplex base station and a full duplex mobile device.

FIG. 10 illustrates an example spectrum for full duplex and half duplex downlink and uplink positioning reference signal transmissions.

FIGS. 11A and 11B are example duplex modes for performing differential round trip time measurements between wireless nodes.

FIG. 12 is a diagram of an example double differential positioning method.

FIG. 13 is a flow diagram of an example method for reporting positioning reference signal measurement values.

FIG. 14 is a flow diagram of an example method for performing a round trip time message exchange.

FIG. 15 is a flow diagram of an example method for determining a location of a wireless node.

FIG. 16 is a block diagram of an example of a computer system.

FIG. 17 is a block diagram of an example mobile device.

FIG. 18 is a block diagram of an example base station.

### DETAILED DESCRIPTION

Techniques are discussed herein for mitigating group delay errors across half duplex and full duplex operations. A 5G NR deployment may include frames with slots configured for half duplex (HD) and full duplex (FD) modes of operation. Wireless nodes, such as user equipment (UE) and base stations (BSs), may be configured to utilize both HD and FD modes for receiving downlink positioning reference signals (DL PRS) and sending uplink positioning reference signals/uplink sounding reference signals (UL PRS/UL SRS). The radio frequency (RF) configurations and hardware operations in HD and FD modes may vary. Different filtering and interference cancellation may be used in both modes, and these variations may impact the group delays associated with the transmit and receive chains in the wireless nodes. For example, additional hardware may be utilized to enable self-interference cancelation in FD slots and may utilize a different group delay as compared to operations in HD slots. In an example, a wireless node may utilize different transmit (Tx) and receive (Rx) chains for FD and HD operations and each Tx/Rx chain may be associated with different delay groups. The group delay errors may also vary because of the increased processing requirements and associated device temperature changes caused by switching between HD and FD operations. The techniques provided herein enable group delay error mitigation across HD and FD modes of operations.

Group delay values are utilized in differential and double differential round trip time (RTT) positioning techniques. In general, a differential RTT method assumes that a UE group delay is constant over multiple RTT measurements, and a double differential RTT method assumes that both the UE and a BS group delay are constant over multiple RTT measurements. In an example, variations in the group delay may be mitigated by measuring both DL PRS and UL SRS in either HD slots or FD slots. The type of slot (e.g., HD or FD) may be reported with the respective reference signal measurements and a network server may be configured to utilize measurements obtained in the same slot. In an example, the operational configuration of the Tx and Rx chains utilized by the UE and BS may be reported with the reference signal measurements such that like configurations (e.g., HD DL PRS and HD UL SRS, FD DL PRS and FD UL SRS) are used in positioning computations. In an example, group delay errors may be mitigated using predefined Rx-Tx time difference measurement types associated with mixed combinations of slot types and/or Tx/Rx operational configurations. For example, a first measurement type may include DL PRS in FD slots and UL SRS in HD slots, and a second measurement type may include DL PRS in HD slots and UL SRS in FD slots. The measurement types may also be based on mixed operational modes for the UE and the BS. The mitigation of group error delays may improve the accuracy of location estimates based on HD and FD reference signal measurements. These techniques are examples, and not exhaustive.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 3GPP Fifth Generate New Radio (5G NR). 5G NR is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The techniques described herein may be used for 5G NR wireless networks and radio technologies, as well as other wireless networks and radio technologies.

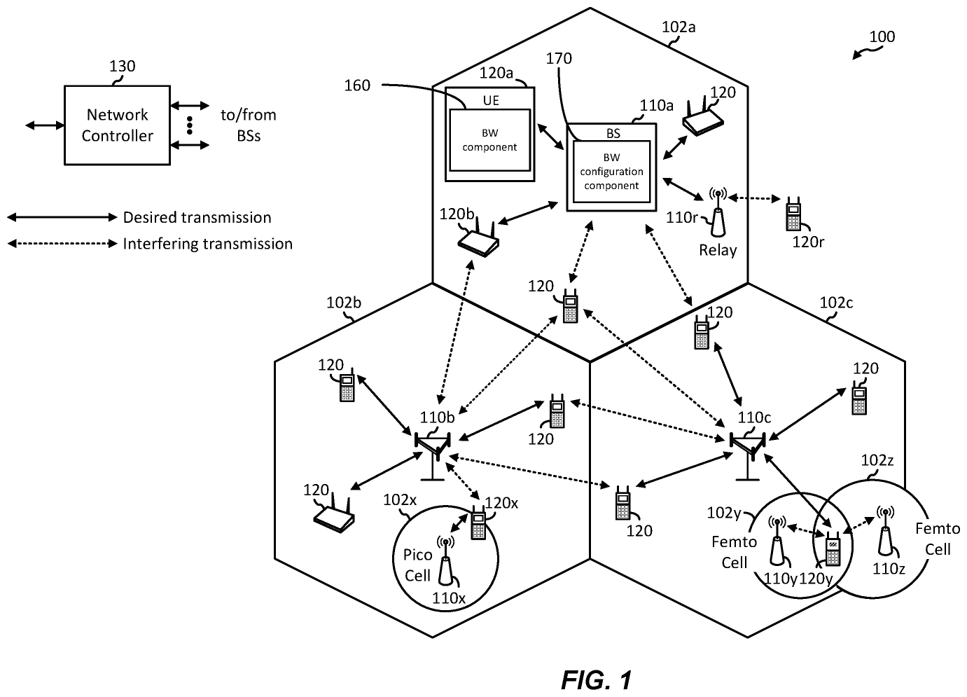

Referring to FIG. 1, an example wireless communication network 100 is shown. The wireless communication network 100 may be a full-duplex NR system (e.g., a full-duplex 5G network). In an example, a mobile device such as a User Equipment (UE) 120a has a bandwidth (BW) component 160 that may be configured for adapting an operating BW of the UE 120a. Similarly, a base station (BS) 110a may include a BW configuration component 170 that may configure a UE, such as UE 120a, to adapt an operating BW.

The wireless communication network 100 may include a number of base stations (BSs) 110 and other network entities. A BS may be a station that communicates with user equipment (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. In some examples, a cell may not necessarily be stationary, and the geographic area of the cell may move according to the location of a mobile BS. In some examples, the BSs may be interconnected to one another and/or to one or more other BSs or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. The BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

The wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. A relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120a, 120b, 120x, 120y, etc.) may be dispersed throughout the wireless communication network 100, and each UE may be stationary or mobile. A UE may also be referred to as a mobile device, a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrow band IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHZ (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 KHz, 240 kHz, etc. The symbol and slot lengths scale with the subcarrier spacing. The CP length also depends on the subcarrier spacing. NR may support transmitting positioning reference signals (PRS) in one or more slots as described herein.

NR may utilize OFDM with a CP on the uplink and downlink and include support for half-duplex operation using TDD. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum). In an example, a the sidelink signals may be configured for full duplex or half duplex operations. A position frequency layer may be used to facilitate full duplex and/or half duplex UE-to-UE transmissions for sidelink positioning applications.

In FIG. 1, a solid line with double arrows indicates desired transmissions between a UE and a serving BS, which is a BS designated to serve the UE on the downlink and/or uplink. A finely dashed line with double arrows indicates potentially interfering transmissions between a UE and a BS.

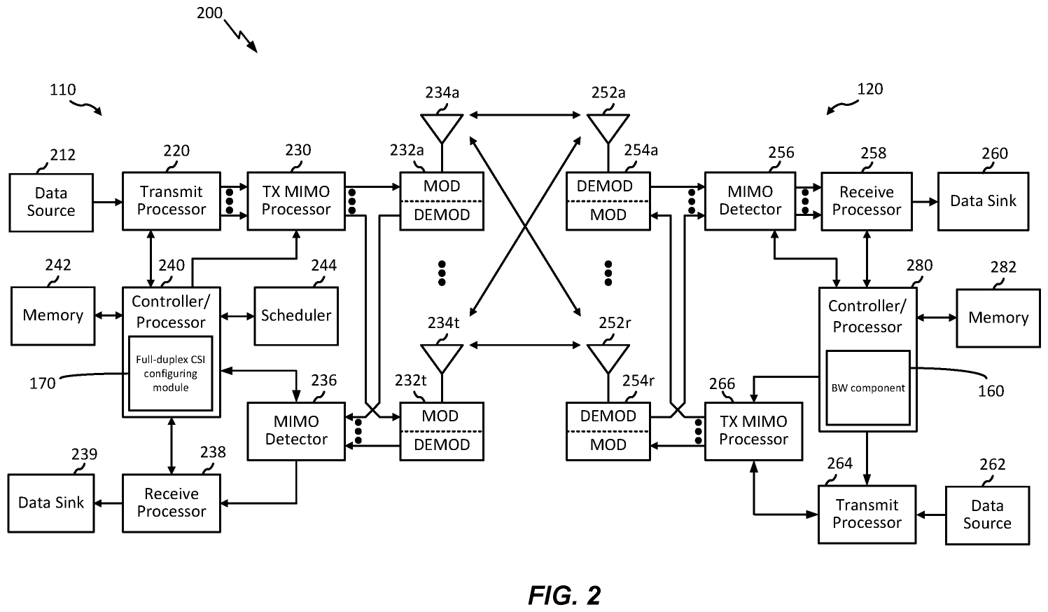

Referring to FIG. 2, example components of BS 110 and UE 120 (e.g., in the wireless communication network 100 of FIG. 1) are shown. The components include antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein.

At the BS 110, a transmit processor 220 may receive data from a data source 212 and control information from a controller/processor 240. For LTE systems, the control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), cell-specific reference signal (CRS), and positioning reference signal (PRS). For NR systems, the control information may include logical and transport channels including a broadcast control channel (BCCH), a paging control channel (PCCH), a common control channel (CCCH), a dedicated control channel (DCCH), a dedicated traffic channel (DTCH), a broadcast channel (BCH), a paging channel (PCH) and a downlink shared channel (DL-SCH). The physical channels in a 5G NR system may include a PBCH, PDCCH, and a PDSCH. The physical signals may include demodulate reference signals (DM-RS), phase tracking reference signal (PT-RS), a channel state information reference signal (CSI-RS), primary and secondary synchronization signals (PSS/SSS) and downlink PRS (DL PRS).

A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in the transceivers 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink.

5G NR wireless networks are expected to provide ultra-high data rates and support a wide scope of application scenarios. Wireless full duplex (FD) communications is an emerging technique and is theoretically capable of doubling the link capacity when compared with half duplex (HD) communications. The main idea of wireless full duplex communications is to enable radio network nodes to transmit and receive simultaneously on the same frequency band in the same time slot. This contrasts with conventional half duplex operation, where transmission and reception either differ in time or in frequency. The wireless communication network 100 may support various FD communication modes.

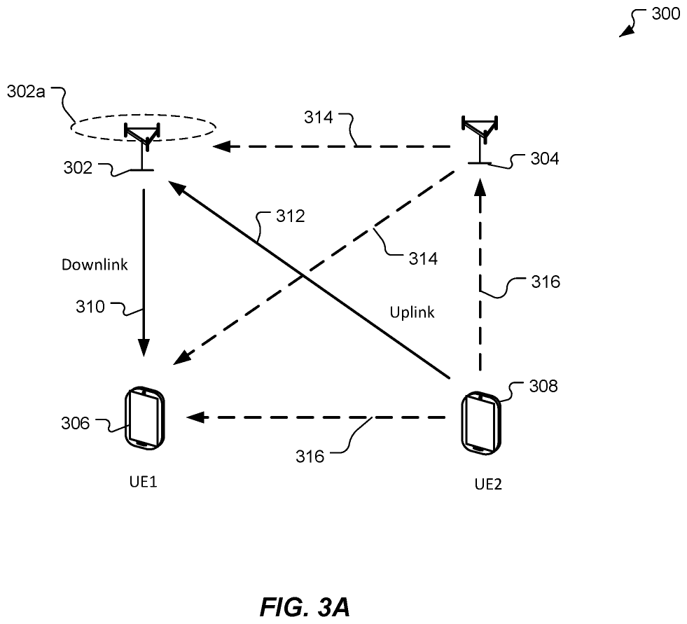

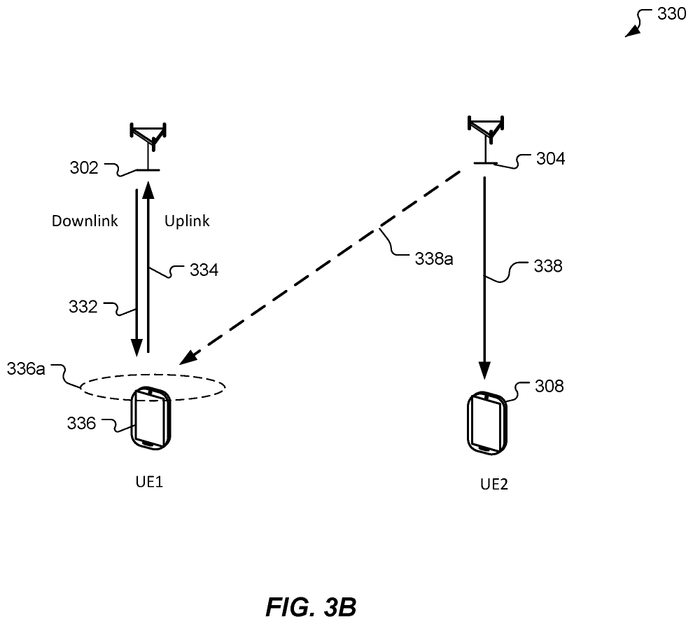

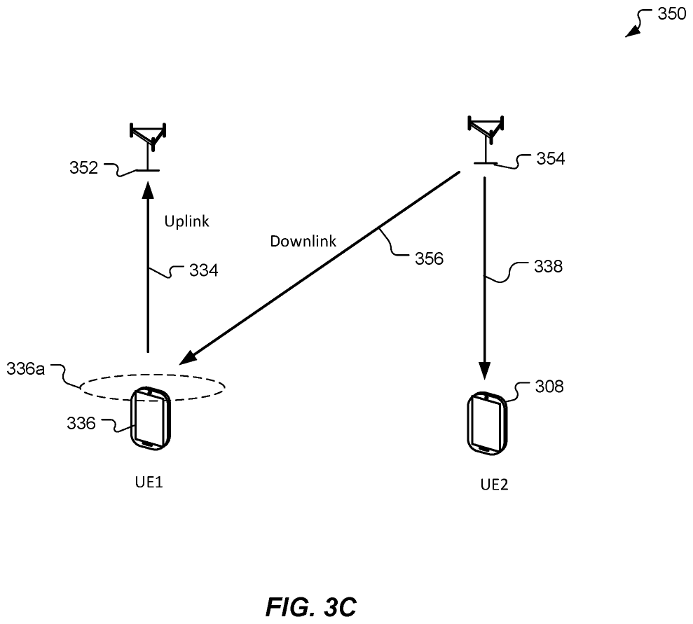

Referring to FIG. 3A, with further reference to FIGS. 1 and 2, an illustration 300 of full duplex communication mode with a full duplex base station and a half duplex UE is shown. The illustration includes the FD BS 302, a HD BS 304, a first HD UE 306, and a second HD UE 308. The FD BS 302 can communicate simultaneously in UL and DL with the two HD UEs 306, 308 using the same radio resources. For example, the FD BS 302 may communicate with the first HD UE 306 via the downlink 310 and with the second HD UE 308 with the uplink 312. The FD BS 302 may be susceptible to self-interference 302a from its downlink to uplink operation, as well as interference 314 from other gNBs such as the HD BS 304. The first HD UE 306 may be susceptible to interference 314 from the HD BS 304 and interference 316 from the second HD UE 308. In general, the self-interference 302a (or transmitter leakage) refers to the signal that leaks from the device transmitter to its own receiver.

Referring to FIG. 3B, an illustration 330 of another full duplex communication mode with a full duplex base station and a full duplex UE is shown. The illustration 330 includes the FD BS 302, the HD BS 304, a FD UE 336, and the HD UE 308. The FD BS 302 and the FD UE 336 are configured to communicate simultaneously via an UL 334 and a DL 332 using the same radio resources. The HD BS 304 is communicating with the HD UE 308 via a DL 338. While communicating, the FD UE 336 may be susceptible to self-interference 336a, and interference 338a from other gNB(s) such as the HD BS 304. The FD UE 336 may also be susceptible to interference transmitting from the HD UE 308.

Referring to FIG. 3C, an illustration 350 of another full duplex communication mode with full duplex UE. The illustration 350 includes a first HD BS 352, a second HD BS 354, the FD UE 336 and the HD UE 308. The FD UE 336 is configured to communicate simultaneously in UL and DL with multiple transmission-reception points (e.g., multiple BSs) using the same radio resources. For example, the FD UE 336 may simultaneously communicate with the first HD BS 352 via the UL 334, and with the second HD BS 354 via the DL 356. The FD UE 336 may be susceptible to self-interference 336a from UL to DL operation. In an example, both UE1 336 and UE2 308 may be configured as FD UEs and capable of full duplex communications via device-to-device (D2D) sidelinks (e.g., PC5).

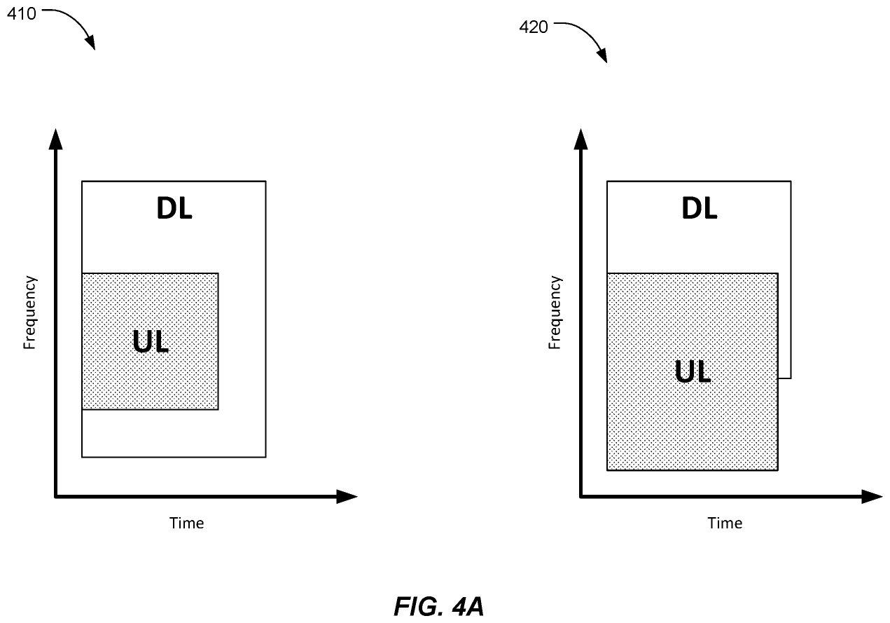

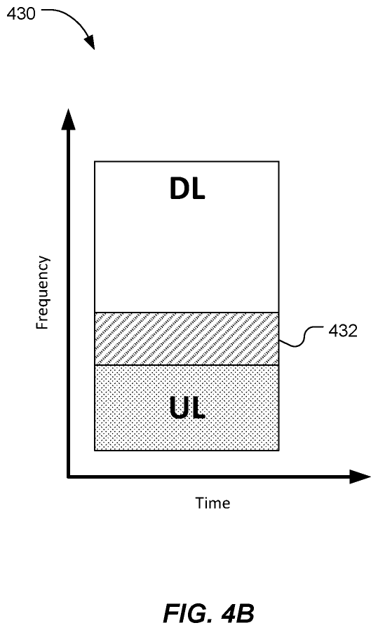

In addition to supporting various FD communication modes (also referred to herein as deployments), the wireless communication system may support various types of FD operation. In-band full duplex (IBFD), for example, is one type of FD operation in which devices can transmit and receive at the same time and on the same frequency resources. As shown in 410 of FIG. 4A, in one aspect, the DL and UL may fully share the same IBFD time/frequency resource (e.g., there may be a full overlap of the DL and UL allocations within the IBFD time/frequency resource). As shown in 420 of FIG. 4A, in one aspect, the DL and UL may partially share the same IBFD time/frequency resource (e.g., there may be a partial overlap of the DL and UL allocations within the IBFD time/frequency resource).

Sub-band FDD (also referred to as flexible duplex) is another type of FD operation in which devices can transmit and receive at the same time but on different frequency resources. Referring to the diagram 430 in FIG. 4B, the DL resource may be separated from the UL resource in the frequency domain by a guard band 432. This mode of operations reduces the self-interference cancellation requirements on the FD device since the leakage is lower.

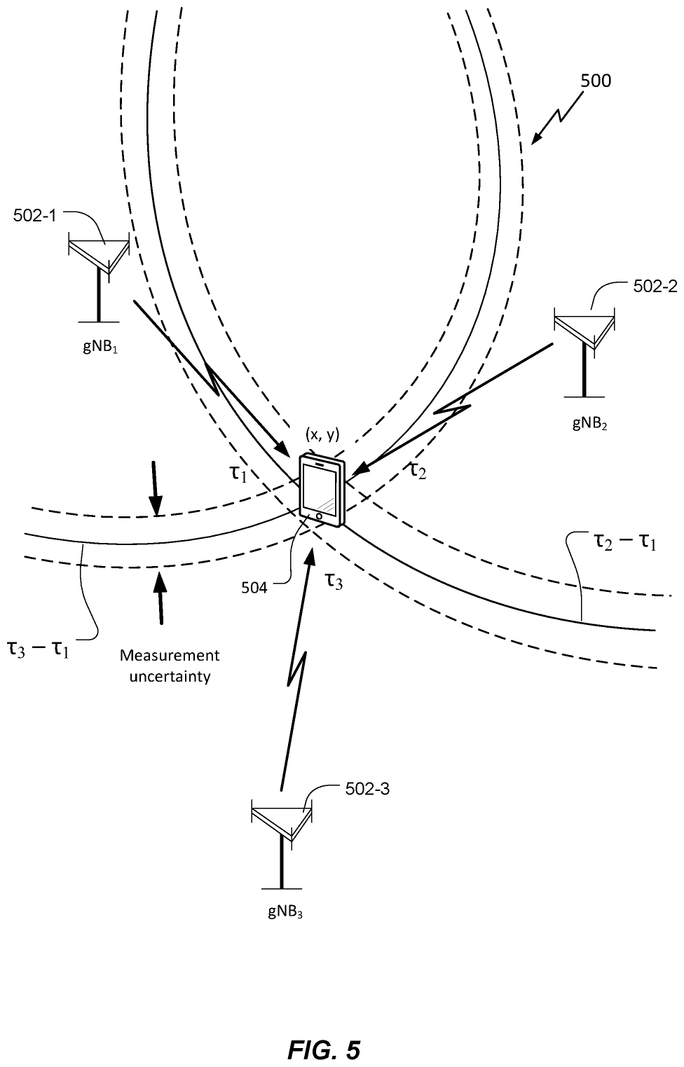

Referring to FIG. 5, an exemplary wireless communications system 500 according to various aspects of the disclosure is shown. In the example of FIG. 5, a UE 504, which may correspond to any of the UEs described herein, is attempting to calculate an estimate of its position, or assist another entity (e.g., a base station or core network component, another UE, a location server, a third party application, etc.) to calculate an estimate of its position. The UE 504 may communicate wirelessly with a plurality of base stations 502-1, 502-2, and 502-3 which may correspond to any combination of the base stations described herein, using RF signals and standardized protocols for the modulation of the RF signals and the exchange of information packets. By extracting different types of information from the exchanged RF signals, and utilizing the layout of the wireless communications system 500 (e.g., the base stations locations, geometry, etc.), the UE 504 may determine its position, or assist in the determination of its position, in a predefined reference coordinate system. In an aspect, the UE 504 may specify its position using a two-dimensional (2D) coordinate system; however, the aspects disclosed herein are not so limited, and may also be applicable to determining positions using a three-dimensional (3D) coordinate system, if the extra dimension is desired. Additionally, while FIG. 5 illustrates one UE 504 and three base stations 502-1, 502-2, 502-3, as will be appreciated, there may be more UEs 504 and more or fewer base stations.

To support position estimates, the base stations 502-1, 502-2, 502-3 may be configured to broadcast positioning reference signals (e.g., PRS, NRS, TRS, CRS, etc.) to UEs in their coverage area to enable a UE 504 to measure characteristics of such reference signals. For example, the observed time difference of arrival (OTDOA) positioning method is a multilateration method in which the UE 504 measures the time difference, known as a reference signal time difference (RSTD), between specific reference signals (e.g., PRS, CRS, CSI-RS, etc.) transmitted by different pairs of network nodes (e.g., base stations, antennas of base stations, etc.) and either reports these time differences to a location server, or computes a location estimate itself from these time differences.

Generally, RSTDs are measured between a reference network node (e.g., base station 502-1 in the example of FIG. 5) and one or more neighbor network nodes (e.g., base stations 502-2 and 502-3 in the example of FIG. 5). The reference network node remains the same for all RSTDs measured by the UE 504 for any single positioning use of OTDOA and would typically correspond to the serving cell for the UE 504 or another nearby cell with good signal strength at the UE 504. In an aspect, where a measured network node is a cell supported by a base station, the neighbor network nodes would normally be cells supported by base stations different from the base station for the reference cell and may have good or poor signal strength at the UE 504. The location computation can be based on the measured time differences (e.g., RSTDs) and knowledge of the network nodes' locations and relative transmission timing (e.g., regarding whether network nodes are accurately synchronized or whether each network node transmits with some known time difference relative to other network nodes).

To assist positioning operations, a location server may provide OTDOA assistance data to the UE 504 for the reference network node (e.g., base station 502-1 in the example of FIG. 5) and the neighbor network nodes (e.g., base stations 502-2 and 502-3 in the example of FIG. 5) relative to the reference network node. For example, the assistance data may provide the center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to OTDOA. The OTDOA assistance data may indicate the serving cell for the UE 504 as the reference network node.

In some cases, OTDOA assistance data may also include “expected RSTD” parameters, which provide the UE 504 with information about the RSTD values the UE 504 is expected to measure at its current location between the reference network node and each neighbor network node, together with an uncertainty of the expected RSTD parameter. The expected RSTD, together with the associated uncertainty, may define a search window for the UE 504 within which the UE 504 is expected to measure the RSTD value. OTDOA assistance information may also include reference signal configuration information parameters, which allow a UE 504 to determine when a reference signal positioning occasion occurs on signals received from various neighbor network nodes relative to reference signal positioning occasions for the reference network node, and to determine the reference signal sequence transmitted from various network nodes in order to measure a signal time of arrival (ToA) or RSTD.

In an aspect, while the location server may send the assistance data to the UE 504, alternatively, the assistance data can originate directly from the network nodes (e.g., base stations 502) themselves (e.g., in periodically broadcasted overhead messages, etc.). Alternatively, the UE 504 can detect neighbor network nodes itself without the use of assistance data.

The UE 504 (e.g., based in part on the assistance data, if provided) can measure and (optionally) report the RSTDs between reference signals received from pairs of network nodes. Using the RSTD measurements, the known absolute or relative transmission timing of each network node, and the known position(s) of the transmitting antennas for the reference and neighboring network nodes, the network or the UE 504 may estimate a position of the UE 504. More particularly, the RSTD for a neighbor network node “k” relative to a reference network node “Ref” may be given as (ToAk−ToARef), where the ToA values may be measured modulo one subframe duration (1 ms) to remove the effects of measuring different subframes at different times. In the example of FIG. 5, the measured time differences between the reference cell of base station 502-1 and the cells of neighboring base stations 502-2 and 502-3 are represented as τ2-τ1 and τ3-τ1, where τ1, τ2, and τ3 represent the ToA of a reference signal from the transmitting antenna(s) of base station 502-1, 502-2, and 502-3, respectively. The UE 504 may then convert the ToA measurements for different network nodes to RSTD measurements and (optionally) send them to a location server. Using (i) the RSTD measurements, (ii) the known absolute or relative transmission timing of each network node, (iii) the known position(s) of physical transmitting antennas for the reference and neighboring network nodes, and/or (iv) directional reference signal characteristics such as a direction of transmission, the UE's 504 position may be determined (either by the UE 504 or a location server).

Still referring to FIG. 5, when the UE 504 obtains a location estimate using OTDOA measured time differences, the necessary additional data (e.g., the network nodes' locations and relative transmission timing) may be provided to the UE 504 by a location server. In some implementations, a location estimate for the UE 504 may be obtained (e.g., by the UE 504 itself or by the location server) from OTDOA measured time differences and from other measurements made by the UE 504 (e.g., measurements of signal timing from global positioning system (GPS) or other global navigation satellite system (GNSS) satellites). In these implementations, known as hybrid positioning, the OTDOA measurements may contribute towards obtaining the UE's 504 location estimate but may not wholly determine the location estimate.

Uplink time difference of arrival (UTDOA) is a similar positioning method to OTDOA, but is based on uplink reference signals (e.g., sounding reference signals (SRS), uplink positioning reference signals (UL PRS), SRS for positioning signals) transmitted by the UE (e.g., UE 504). Further, transmission and/or reception beamforming at the base station 502-1, 502-2, 502-3 and/or UE 504 can enable wideband bandwidth at the cell edge for increased precision. Beam refinements may also leverage channel reciprocity procedures in 5G NR.

In NR, there is no requirement for precise timing synchronization across the network. Instead, it is sufficient to have coarse time-synchronization across gNBs (e.g., within a cyclic prefix (CP) duration of the OFDM symbols). Coarse timing synchronization is generally sufficient for Round-trip-time (RTT)-based methods, and as such, are a practical positioning methods in NR.

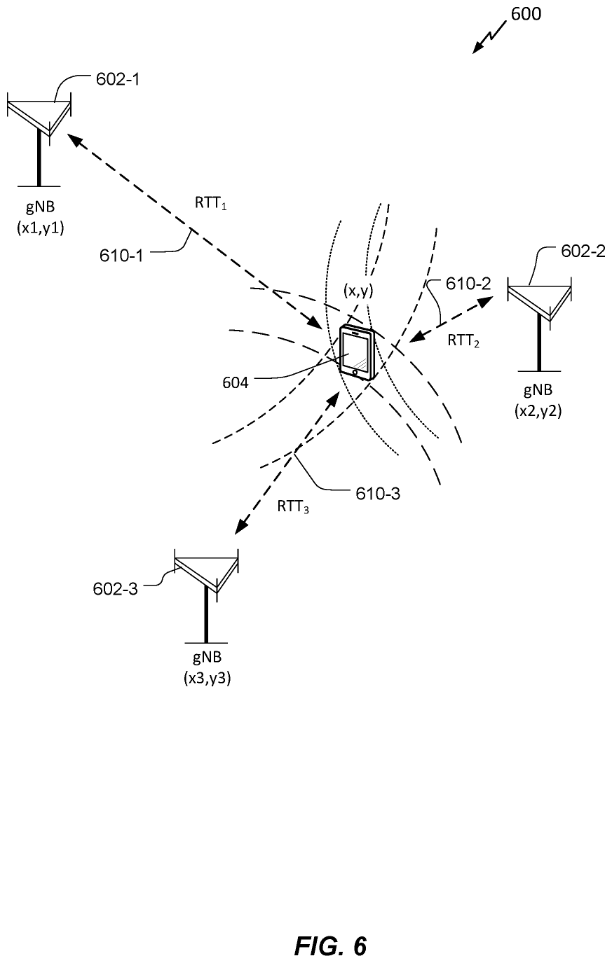

Referring to FIG. 6, an exemplary wireless communications system 600 according to aspects of the disclosure is shown. In the example of FIG. 6, a UE 604 (which may correspond to any of the UEs described herein) is attempting to calculate an estimate of its position, or assist another entity (e.g., a base station or core network component, another UE, a location server, a third party application, etc.) to calculate an estimate of its position. The UE 604 may communicate wirelessly with a plurality of base stations 602-1, 602-2, and 602-3 (which may correspond to any of the base stations described herein) using RF signals and standardized protocols for the modulation of the RF signals and the exchange of information packets. By extracting different types of information from the exchanged RF signals, and utilizing the layout of the wireless communications system 600 (i.e., the base stations' locations, geometry, etc.), the UE 604 may determine its position, or assist in the determination of its position, in a predefined reference coordinate system. In an aspect, the UE 604 may specify its position using a two-dimensional coordinate system; however, the aspects disclosed herein are not so limited, and may also be applicable to determining positions using a three-dimensional coordinate system, if the extra dimension is desired. Additionally, while FIG. 6 illustrates one UE 604 and three base stations 602-1, 602-2, 602-3, as will be appreciated, there may be more UEs 604 and more base stations.

To support position estimates, the base stations 602-1, 602-2, 602-3 may be configured to broadcast reference RF signals (e.g., PRS, NRS, CRS, TRS, CSI-RS, PSS, SSS, etc.) to UEs 604 in their coverage area to enable a UE 604 to measure characteristics of such reference RF signals. For example, the UE 604 may measure the ToA of specific reference RF signals (e.g., PRS, NRS, CRS, CSI-RS, etc.) transmitted by at least three different base stations and may use the RTT positioning method to report these ToAs (and additional information) back to the serving base station (e.g., base station 602-2) or another positioning entity (e.g., a location server).

In an aspect, although described as the UE 604 measuring reference RF signals from a base station 602-1, 602-2, 602-3, the UE 604 may measure reference RF signals from one of multiple cells supported by a base station 602-1, 602-2, 602-3. Where the UE 604 measures reference RF signals transmitted by a cell supported by a base station 602-2, the at least two other reference RF signals measured by the UE 604 to perform the RTT procedure would be from cells supported by base stations 602-1, 602-3 different from the first base station 602-2 and may have good or poor signal strength at the UE 604.

In order to determine the position (x, y) of the UE 604, the entity determining the position of the UE 604 needs to know the locations of the base stations 602-1, 602-2, 602-3, which may be represented in a reference coordinate system as (xk, yk), where k=1, 2, 3 in the example of FIG. 6. Where one of the base stations 602-2 (e.g., the serving base station) or the UE 604 determines the position of the UE 604, the locations of the involved base stations 602-1, 602-3 may be provided to the serving base station 602-2 or the UE 604 by a location server with knowledge of the network geometry. Alternatively, the location server may determine the position of the UE 604 using the known network geometry.

Either the UE 604 or the respective base station 602-1, 602-2, 602-3 may determine the distance (dk, where k=1, 2, 3) between the UE 604 and the respective base station 602-1, 602-2, 602-3. In an aspect, determining the RTT 610-1, 610-2, 610-3 of signals exchanged between the UE 604 and any base station 602-1, 602-2, 602-3 can be performed and converted to a distance (dk). RTT techniques can measure the time between sending a signaling message (e.g., reference RF signals) and receiving a response. These methods may utilize calibration to remove any processing and hardware delays. In some environments, it may be assumed that the processing delays for the UE 604 and the base stations 602-1, 602-2, 602-3 are the same. In an example, the processing delays may be associated with the duplex modes or operational modes of the UE and the base stations because duplex operations may utilize different receive and transmit chains, and may require different filtering to reduce self-interference.

Once each distance dk is determined, the UE 604, a base station 602-1, 602-2, 602-3, or the location server can solve for the position (x, y) of the UE 604 by using a variety of known geometric techniques, such as, for example, trilateration. From FIG. 6, it can be seen that the position of the UE 604 ideally lies at the common intersection of three semicircles, each semicircle being defined by radius dk and center (xk, yk), where k=1, 2, 3.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE 604 from the location of a base station 602-1, 602-2, 602-3). The intersection of the two directions at or near the point (x, y) can provide another estimate of the location for the UE 604.

A position estimate (e.g., for a UE 604) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

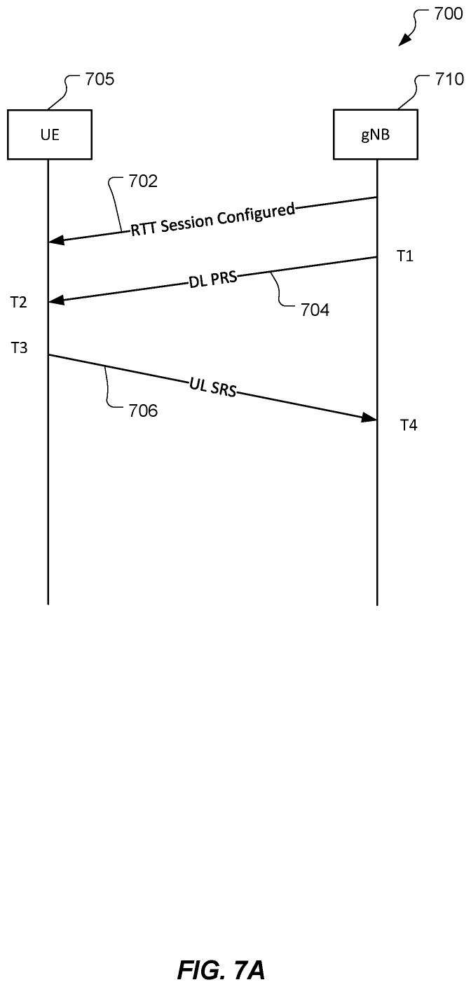

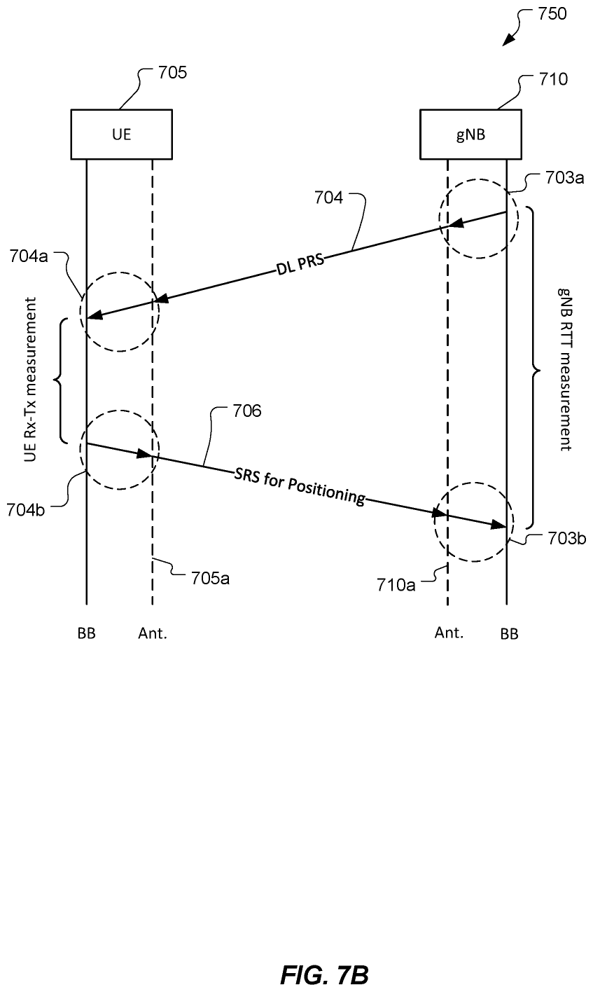

Referring to FIG. 7A, an example round trip message flow 700 between two wireless nodes such as a user equipment 705 and a base station 710 is shown. The UE 705 is an example of the UE 120 and the base station 710 may be a BS 110. In general, RTT positioning methods utilize a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. The example message flow 700 may be initiated by the base station 710 with a RTT session configure message 702. The base station may utilize the long term evolution positioning protocol (LPP) messaging to configure the RTT session. At time T1, the base station 710 may transmit a DL PRS 704, which is received by the UE 705 at time T2. In response, the UE 705 may transmit a Sounding Reference Signal (SRS) for positioning message (e.g., UL-SRS) 706 at time T3 which is received by the base station 710 at time T4. The distance between the UE 705 and the base station 710 may be computed as:

$$distance = \frac{c}{2} ( ( T 4 - T 1 ) - ( T 3 - T 2 ) ) \qquad ( 1 )$$

$$where c = speed of light .$$

Referring to FIG. 7B, with further reference to FIG. 7A, a diagram 750 of example impacts of group delay errors within wireless transceivers are shown. The diagram 750 depicts an example RTT exchange used for positioning a client device such as described in FIG. 7A. In an example, the UE 705 and the base station 710, may be configured to exchange positioning reference signals such as the DL PRS 704 and the SRS for positioning signal 706 (which may also be referred to as a UL PRS) such as described in FIG. 7A. The UE 705 may have one or more antennas 705a and associated base band processing components. Similarly, the base station 710 may have one or more antennas 710a and base band processing components. The respective internal configurations of the UE 705 and the base station 710 may cause delay times associated with the transmission and reception of PRS signals. In general, a group delay is a transit time of a signal through a device versus frequency. For example, a BSTX group delay 703a represents the difference in time the base station 710 records the transmission of the DL PRS 704 and the time the signal leaves the antenna 710a. A BSRX group delay 703b represents the difference in time the SRS for positioning signal 706 arrives at the antenna 710a and the time the processors in the base station 710 receive an indication of the SRS for positioning signal 706. The UE 705 has similar group delays such as the UERX group delay 704a and the UETX group delay 704b. The group delays associated with the network stations may create a bottleneck for terrestrial based positioning because the resulting time differences lead to inaccurate position estimates. For example, a 10 nanosecond group delay error equates to approximately a 3 meter error in the position estimate. Different frequencies may have different group delay values in a transceiver, thus different PRS and SRS resources may be associated with different timing error groups (TEGs). Other electrical and physical features may further impact the actual delay time within a TEG. For example, changes in orientation relative to received and/or transmitted beams may utilize different antenna elements and may cause different levels of delay. Thermal properties of the receive and transmit chains may cause clock drift and degrade the quality of a TEG calibration. Since HD and FD operational modes may utilize different transmit and receive chains, the group delays errors associated with the RTT exchange may vary based on whether the DL PRS and UL SRS are utilizing HD or FD slots and/or with the UE and the BS are operating in HD or FD modes.

Referring to FIG. 8, an example spectrum 800 for a full duplex base station and half duplex mobile devices is shown. In some aspects, there may be flexible DL/UL operation in time (across and within slots) and across multiple UEs. FIG. 8 illustrates an example use of time/frequency resources for a FD BS 802 (e.g., a gNB) and a plurality of HD UEs (e.g., UE1, UE2, and UE3). As shown in the spectrum 800, there may be simultaneous PDSCH and PUSCH grants for the same subframe/slot (for different UEs).

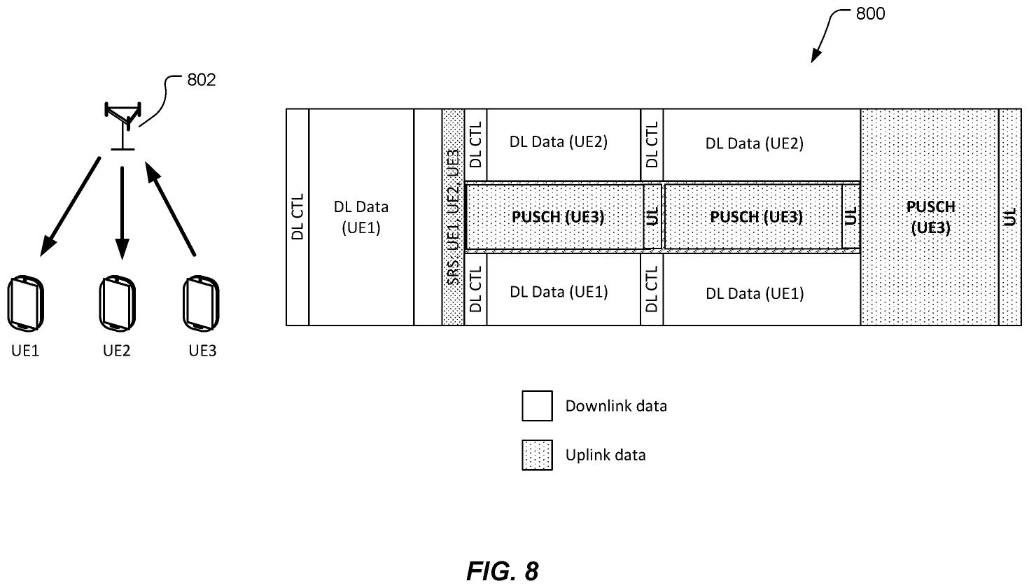

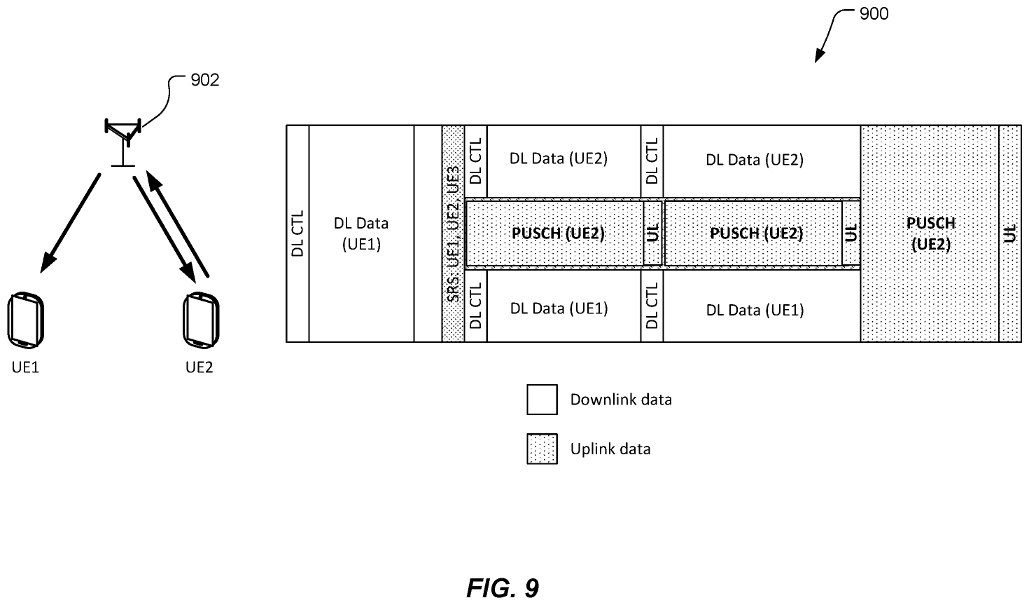

Referring to FIG. 9, an example spectrum 900 for full duplex base station and a full duplex mobile device is shown. FIG. 9 illustrates another example use of time/frequency resources for a FD BS 902 and FD UEs. As shown in the spectrum 900, compared to spectrum 800 in FIG. 8, there may be simultaneous PDSCH and PUSCH grants for the same subframe/slots for the same UE (e.g., UE2) and/or different UEs. For example, for a FD UE (e.g., UE2) there may be a simultaneous UL and DL grant.

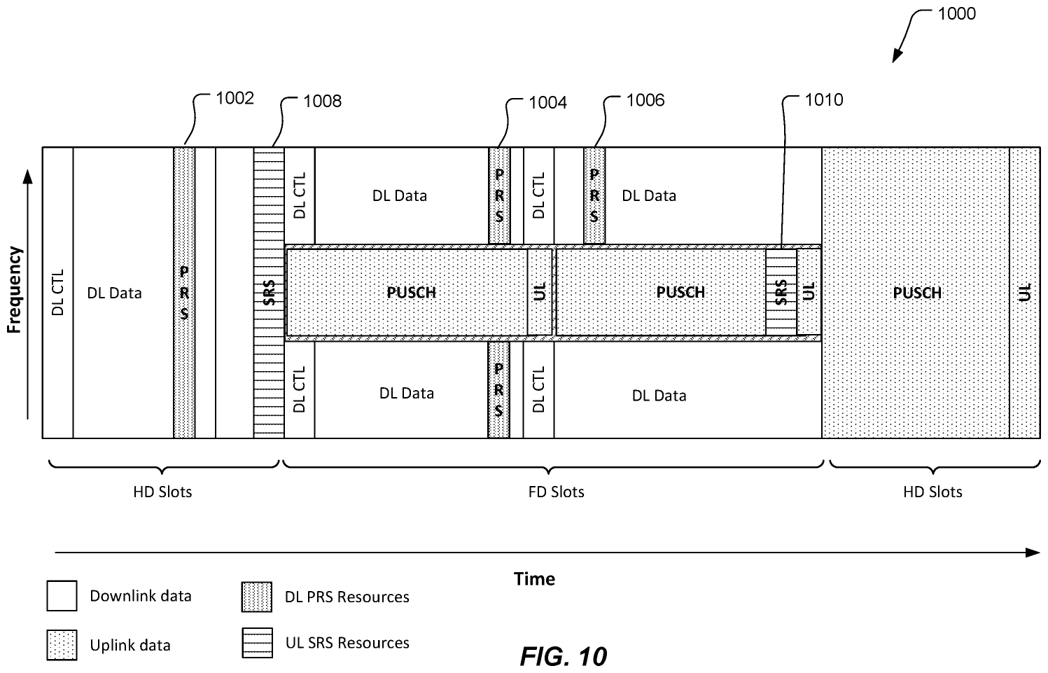

Referring to FIG. 10, an example spectrum 1000 for full duplex and half duplex downlink and uplink positioning reference signal transmissions is shown. The spectrum 1000 is an example use of time/frequency resources of a FD UE, such as the full duplex spectrums 800, 900, with DL PRS and UL SRS resources added. For example, the spectrum 1000 includes a first DL PRS 1002, a second DL PRS 1004, a third DL PRS 1006, a first UL SRS 1008, and a second UL SRS 1010. The first DL PRS 1002 occurs during HD slots and is not overlapped with the uplink regions (e.g., the PUSCH). The second DL PRS 1004 occurs during FD slots and is overlapped with the uplink regions. The third DL PRS 1006 occurs in a FD slot but is not considered overlapped with the uplink region because it occupies a portion of the DL bandwidth. The first UL SRS 1008 occurs during HD uplink slots, and the second UL SRS 1010 occurs during a FD slot. The locations of the DL PRS and UL SRS in the spectrum 1000 are examples and not limitations as other slots and resources may be used.

In an example, a wireless node (e.g., UE, BS) or other resource in the wireless communication network 100 may configure DL PRS and UL SRS resources based on whether a slot is in a HD region or a FD region. The positioning frequency layer may be expanded by including a field or other information element (IE) to indicate information of slot class (either HD or FD) in the definitions of the positioning frequency layer. The positioning frequency layer may include a collection of PRS resource sets across one or more base stations (e.g., TRPs) with the PRS resources configured for HD or FD slots. The network may configure the PRS resources separately for FD operation and HD operation. For example, one PRS resource may be configured for FD slots, and another PRS resource may be provided for HD slots. Positioning frequency layers and PRS resources sets may be configured for FD or HD slots.

In operation, the wireless nodes (e.g., UE, BS) may utilize different receive and transmit chains for HD and FD operations. For example, the RF configurations and hardware operations in HD and FD modes may vary. Different filtering and interference cancellation may be used in both modes, and these variations may impact the group delays associated with the transmit and receive chains in the wireless nodes. Additional hardware may be utilized to enable self-interference cancelation in FD slots and may utilize a different group delay as compared to operations in HD slots. Each Tx/Rx chain may be associated with different delay groups. The group delay errors may also vary because of the increased processing requirements and associated device temperature changes caused by switching between HD and FD operations. Prior group delay mitigation methods, such as differential RTT and double differential RTT may not work when the group delay is dynamically changing across HD and FD slots and the wireless nodes are varying Rx/Tx receive chains to obtain the Rx-Tx measurements. The techniques provided herein enable group delay error mitigation across HD and FD modes of operations.

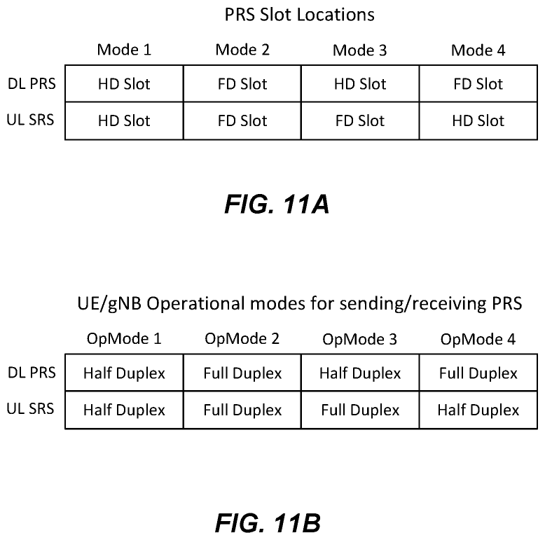

Referring to FIGS. 11A and 11B, with further reference to FIG. 10, example duplex modes for performing differential round trip time measurements between wireless nodes are shown. FIG. 11A illustrates four different duplex modes (i.e., Modes 1-4) based on the type of slot reference signals are transmitted and received. Wireless nodes in a network may be configured to utilize reference signals utilizing specific HD and/or FD slots based on the predefined modes. To mitigate the common group delay with differential RTT and/or double differential RTT, when such differential RTT positioning sessions are scheduled, the wireless nodes (e.g., UE, BS) may measure the Rx-Tx time difference of the DL PRS and UL SRS with one of the predefined modes and report the measurements with an indication of the mode type. For example, in a first mode (Mode 1), the wireless nodes may utilize DL PRS and UL SRS in HD slots, such as the first DL PRS 1002 and the first UL SRS 1008, to perform differential RTT measurements and determine a group error associated with the first mode. In a second mode (Mode 2), the wireless nodes may utilize reference signals in FD slots such as the second and third DL PRS 1004, 1006 and the second UL SRS 1010 and determine an error group associated with the second mode. Predetermined mixed modes of operations may also be used such as a third mode (Mode 3) including DL PRS in HD slots and UL SRS in FD slots, and a fourth mode (Mode 4) with DL PRS in FD slots and UL SRS in HD slots. In an example, the wireless nodes may be configured to batch report multiple Rx-Tx time difference measurements and the mode associated with each of the measurements.

FIG. 11B illustrates four different operational modes (i.e., OpModes 1-4) based on the operational configuration of a wireless node when the reference signals are sent and received. The OpModes define four types of Rx-Tx time difference measurements based on combinations of RF chains used for HD and FD operations. The use of operational configurations of the wireless nodes, as compared to the slot configurations in FIG. 11A, may be preferred because a wireless node utilizing FD slots may ignore the additional RF filtering based on the actual level of self-interference associated with a reference signal. The table in FIG. 11B may apply to UEs and BSs as two example wireless nodes, but the operation modes may apply to any two wireless nodes participating in a RTT message exchange. In a first operational mode (OpMode 1), both the DL PRS and UL SRS are received and transmitted in a HD mode, and in a second operational mode (OpMode 2), both utilize a FD mode. Mixed operational modes may also be defined, such as a third operational mode (OpMode 3) with the DL PRS received when the wireless node in HD mode and the UL SRS is transmitted when the wireless node is in FD mode, and a fourth operational mode (OpMode 4) with the DL PRS is received in FD mode and the UL SRS is transmitted in HD mode. The Rx-Tx measurements may be reported with the corresponding operation mode. Batch measurement reports may also be provided with the associated operational mode for each Rx-Tx measurement.

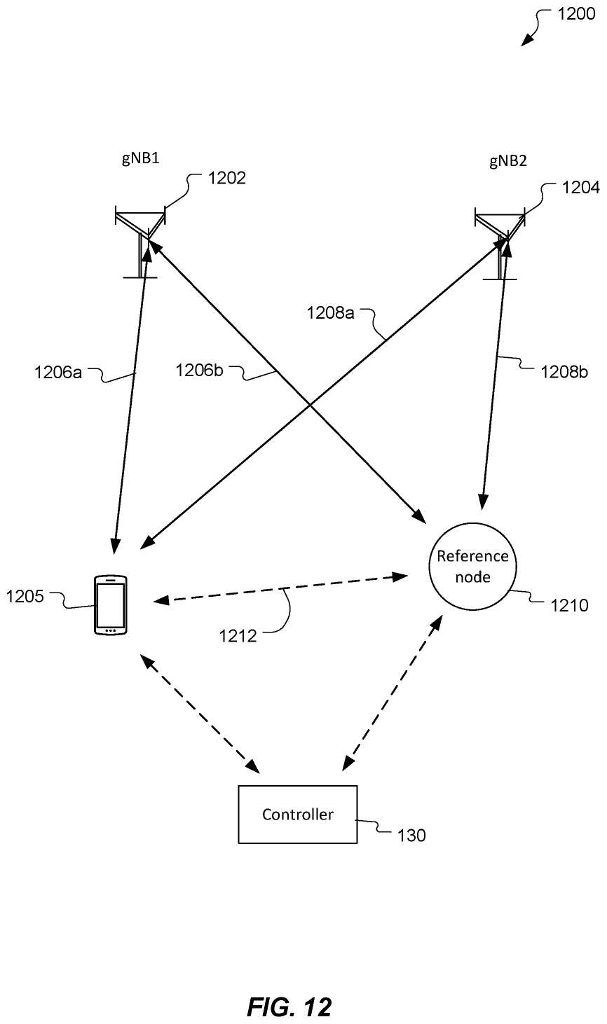

Referring to FIG. 12, a diagram 1200 of an example double difference positioning method is shown. The diagram 1200 includes a plurality of wireless nodes such as a first BS 1202, a second BS 1204, a target UE 1205, and a reference node 1210. The BS 1202, 1204 and the target UE 1205 may be configured for FD and/or HD operations. The reference node 1210 may be a UE and/or a TRP, or another device configured for FD and/or HD operations and to send and receive positioning reference signals. In an example, the target UE 1205 and the reference node 1210 may be configured to communicate with a network entity such as the network controller 130 (e.g., LMF) via one or more communication protocols. (e.g., via LPP, etc.). In an example, the target UE 1205 and the reference node 1210 may be configured to communicate via device-to-device (D2D) link 1212. The D2D link 1212 may be based on technologies such as NR sidelink (e.g., via the physical sidelink control channel (PSCCH), physical sidelink shared channel (PSSCH)). In a vehicle-to-everything (V2X) network, the reference node 1210 may be a roadside unit (RSU), and the sidelink may be based on the PC5 protocol. Other D2D technologies may also be used.

In operation, the first BS 1202 is configured to perform a first RTT exchange 1206a with the target UE, and a second RTT exchange 1206b with the reference node 1210. The first and second RTT exchanges 1206a-b may comprise a single DL PRS transmitted by the first BS 1202 which is receive by both the target UE 1205 and the reference node 1210, and respective UL SRS transmitted by the target UE 1205 and the reference node 1210. Preferably, the same instance of the DL PRS is received by the target UE 1205 and the reference node 1210, but different instances of the DL PRS may be received by the target UE 1205 and the reference node 1210. The second BS 1204 is configured to perform RTT exchanges with the target UE 1205 and the reference node 1210, such as a third RTT exchange 1208a and a fourth RTT exchange 1208b. In general, since the reference node 1210 is in a known location, the Rx-Tx time difference measurement (including any timing errors) may be determined based on the known propagation time of the RF signals. In actual implementations, since the BSs 1202, 1204, the target UE 1205, and the reference node 1210 may utilize different transmit and receive chains for HD and/or FD modes of operation, the timing errors may vary based on the slot locations of the DL PRS/UL SRS and the corresponding modes of operations as described in FIGS. 11A and 11B. The variations in the timing errors may be mitigated when the stations utilizing differential or double differential RTT positioning methods are configured to exchange messages according to predetermined duplex mode configurations. The target UE 1205 and the reference node 1210 are configured to report their respective Rx-Tx measurement values and the associated slot based and/or operational mode associated with the measurements. In an example, each of the slot based modes (e.g., Modes 1-4) and operational modes (e.g., OpModes 1-4) may be associated with an error delay group.

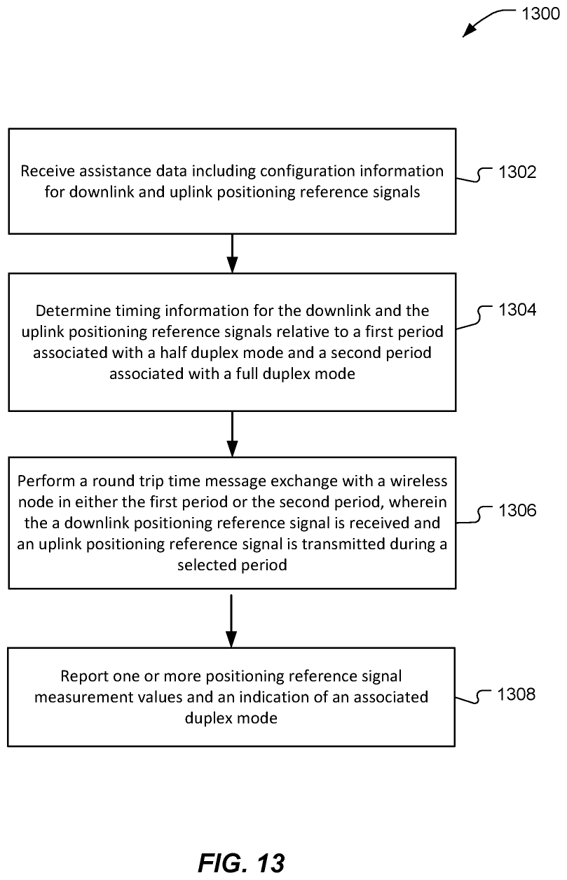

Referring to FIG. 13, with further reference to FIGS. 1-12, a method 1300 for reporting positioning reference signal measurement values includes the stages shown. The method 1300 is, however, an example and not limiting. The method 1300 may be altered, e.g., by having stages added, removed, rearranged, combined, performed concurrently, and/or having single stages split into multiple stages.

At stage 1302, the method includes receiving assistance data including configuration information for downlink and uplink positioning reference signals. A wireless node such as a UE 1205, a reference node 1210, or a BS 1202, 1204, is a means for receiving assistance data. In an example, a location server may be configured to provide reference signal assistance data via network signaling techniques such as LPP/NRPPa and Radio Resource Control (RRC) System Information Blocks (SIBs). The assistance data may include PRS resource information for DL PRS and UL SRS. The resource information may include slot timing information and an indication of whether the reference signal will be transmitted in a FD or HD slot. In an example, the assistance data may include timing information associated with HD and FD slots to enable stations to utilize respective HD and FD modes.

At stage 1304, the method includes determining timing information for the downlink and uplink positioning reference signals relative to a first period associated with a half duplex mode and a second period associated with a full duplex mode. A wireless node such as the target UE 1205, the reference node 1210, or the BSs 1202, 1204, is a means for determining timing information. In an example, the PRS resource information may include an indication of whether the PRS is transmitted in a HD or FD slot. In an example, the PRS resource information may include coarse timing information which may be compared to assistance data indicating the timing of HD and FD slots. For example, referring to FIG. 10, the first DL PRS 1002 and the first UL SRS 1008 are associated with a HD mode, and the second and third DL PRS 1004, 1006 and the second UL SRS 1010 are associated with a FD mode.

At stage 1306, the method includes performing a round trip time message exchange with a wireless node in either the first period or the second period, wherein the downlink positioning reference signal is received and an uplink positioning reference signal is transmitted during a selected period. The UE 1205, the reference node 1210, or the BSs 1202, 1204 are means for performing a RTT message exchange. In an example, the first period may correspond to HD slots and the second period may correspond to FD slots. In one example, the RTT exchange may include the first DL PRS 1002 and the first UL SRS 1008 which are in a period for HD slots. In another example, the RTT exchange may include the second or third DL PRS 1004 and the second UL SRS 1010 which are in a period for FD slots. While FIG. 10 shows a limited spectrum with a few example PRS slots, the DL PRS and UL PRS in an RTT exchange may utilize other slots not shown in FIG. 10 such that each RTT exchange occurs exclusively within HD slots or FD slots. Using the same slot configurations for both the DL and UL messages mitigates the errors introduced by different Rx and Tx chains associated with the different modes (e.g., HD mode or FD mode). Thus, the Rx-Tx measurements in one example are based on DL PRS and UL SRS transmitted in time periods associated with HD slots, and the Rx-Tx measurements in a second example are based on DL PRS and UL SRS transmitted in time periods associated with FD slots.

At stage 1308, the method includes reporting one or more positioning reference signal measurement values and an indication of the duplex mode. The UE 1205, the reference node 1210, or the BSs 1202, 1204 are means for reporting the one or more PRS measurement values. In an example, the wireless nodes in a network may provide the measurement reports to a network server, such as a Location Management Function (LMF), via LPP messaging or other signaling techniques. For example, a UE may report Rx-Tx measurements and a BS (e.g., gNB) may report the RTT measurements to the LMF. Other measurement values such as RSRP and AoA for the DL PRS may also be reported. The indication of the duplex mode may indicate that DL PRS and UL SRS were both transmitted in HD slots, or both transmitted in FD slots. In an example, the wireless nodes may be configured to provide batch measurement reports with an associated duplex mode for each measurement. The LMF may receive multiple measurement pairs associate with HD slots and FD slots and may be configured to determine group error delays associated with each mode.

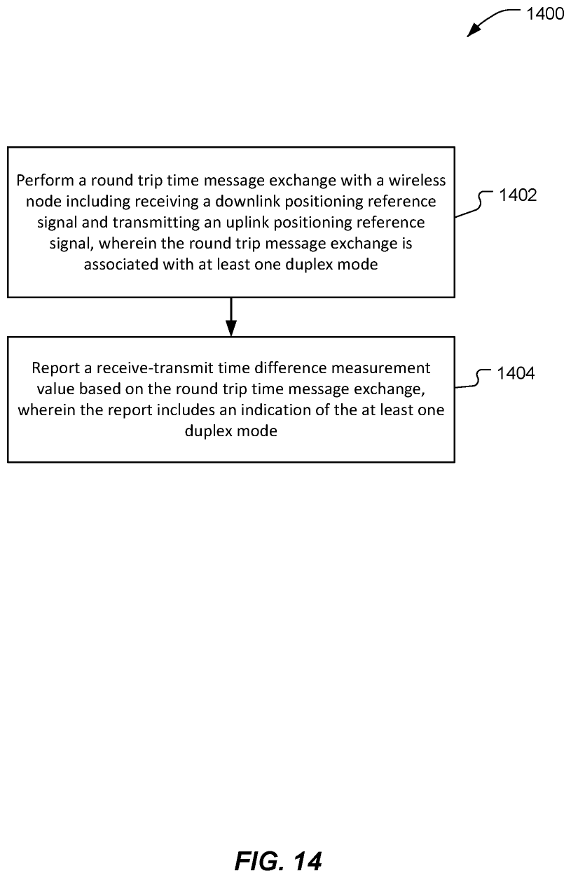

Referring to FIG. 14, with further reference to FIGS. 1-12, a method 1400 for performing a round trip time message exchange includes the stages shown. The method 1400 is, however, an example and not limiting. The method 1400 may be altered, e.g., by having stages added, removed, rearranged, combined, performed concurrently, and/or having single stages split into multiple stages.

At stage 1402, the method includes performing a round trip time message exchange with a wireless node including receiving a downlink positioning reference signal and transmitting an uplink positioning reference signal, wherein the round trip message exchange is associated with at least one duplex mode. A wireless node such as a UE 1205, or a reference node 1210, is a means for performing a RTT message exchange. In an example, the UE 1205 or the reference node 1210 may receive assistance data from a network server (e.g., LMF) via one or more BSs. For example, the assistance data may be received by LPP or RRC messaging. The assistance data may include PRS resource information and duplex mode configurations for the network. In an example, the UE 1205 may be configured to select DL PRS and UL SRS to measure Rx-Tx measurements such that both the PRS/SRS are transmitted in the same duplex mode (i.e., both in HD slots, or both in FD slots). For example, referring to FIG. 11A, the UE may be configured to obtain the Rx-Tx measurements based on Mode 1 or Mode 2. In another example, mixed modes may be used for low latency positioning use cases. The UE 1205 may be configured to measure Rx-Tx time difference measurements based on the closest DL PRS and UL SRS even though the PRS/SRS are scheduled in different duplex modes (e.g., one in a HD slot and one in a FD slot). Referring to FIG. 11A, the UE may be configured to obtain the Rx-Tx measurements based on Mode 3 or Mode 4. In an example, referring to FIG. 11B, the UE may be configured to obtain Rx-Tx measurements based on the operational modes in which the DL PRS are received and the UL SRS are transmitted. The operational modes may not correspond to the defined slot configuration. For example, the UE 1205 may be configured to receive a DL PRS transmitted in a FD slot while in a HD mode. The UE 1205 may be configured to report the operational mode (e.g., OpModes 1-4) associated with the Rx-Tx measurements. Other reference signal measurements such as Reference Signal Received Power (RSRP) and Reference Signal Received Quality (RSRQ), and AoA may also be obtained based on the DL PRS.

At stage 1404, the method includes reporting a receive-transmit difference measurement value based on the round trip time message exchange, wherein the report includes an indication of the at least one duplex mode. The UE 1205 and the reference node 1210 are means for reporting the Rx-Tx difference measurement. In an example, the UE 1205 may be configured to provide one or more measurement reports to a network server (e.g., LMF) via LPP messaging. Other signaling, such as RRC, may also be used. The measurement reports may include an information element to indicate a duplex mode that the Rx-Tx measurement is based on (e.g., Mode 1-4, OpMode 1-4). Other predefined modes may also be used. The network server may be configured to utilize the duplex modes to mitigate group delay errors. In an example, the different duplex modes may be associated with different group delay error values. In an example, the UE 1205 may be configured to provide batch measurement reports, with each measurement value including the associated duplex mode information.

In an example, a wireless node or other network server (e.g., UE, LMF) may send an on-demand request for DL PRS and/or UL SRS scheduled in HD mode or FD mode. Such an on-demand request may enable consistent RF operations (e.g., with a consistent group delay) across the PRS and SRS processing. Mixed combinations of duplex modes for pairs of DL PRS and UL SRS may also be available for on-demand requests. For example, the on-demand request may always configure DL PRS in HD slots, and UL SRS in FD slots (i.e., Mode 3). This may enable consistent RF operations (e.g., known group delay) across each pair of PRS and SRS processing. Network nodes (e.g., UE, BS) may be configured to dynamically indicate whether it adjusts or calibrates its group delay in FD mode. For example, a network node may provide a message to the LMF indicating that it has calibration information for a HD mode. The LMF may utilize this indication to select measurements in HD modes if there is no group delay mitigation method applied. The network nodes may also indicate whether the group delay in FD is constant over a period of time (e.g., due to thermal instabilities caused by the increased power used in FD operations). The LMF may utilize an indication of a varying delay value to utilize a group delay mitigation method, such as differential RTT/double differential RTT could be applied during some period of measurements.

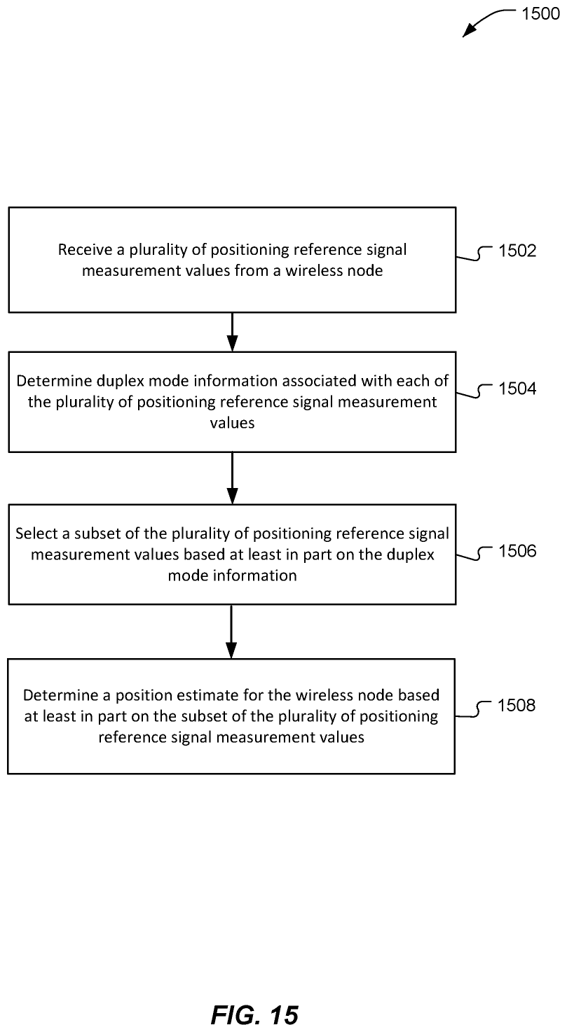

Referring to FIG. 15, with further reference to FIGS. 1-12, a method 1500 for determining a location of a wireless node includes the stages shown. The method 1500 is, however, an example and not limiting. The method 1500 may be altered, e.g., by having stages added, removed, rearranged, combined, performed concurrently, and/or having single stages split into multiple stages.

At stage 1502, the method includes receiving a plurality of positioning reference signal measurement values from a wireless node. A network server, such as the network controller 130, is a means for receiving the plurality of PRS measurement values. In an example, referring to FIG. 6, the UE 604 may be configured to perform RTT exchanges with a plurality of BS stations and report the Rx-Tx measurement values to a network server such as an LMF. The measurement reports may be received via one or more LPP messages, or other signaling techniques. The measurement reports may include additional DL PRS measurement information such as RSRP and AoA values. In an example, the measurement reports may also indicate a duplex mode (e.g., Modes 1-4) based on the slot type (e.g., HD or FD) a pair of reference signals were received and transmitted. The measurement reports may include an indication of an operational mode (e.g., OpMode 1-4) used to receive and transmit the reference signals. In an example, the measurement reports may include a batch of measurement values and corresponding duplex mode and/or operational mode information associated with each measurement.

At stage 1504, the method includes determining a duplex mode information associated with each of the plurality of positioning reference signal measurement values. The network server is a means for determining the duplex mode information. In an example, the duplex mode information may be the duplex mode and/or operational mode information included in measurement reports received from the wireless node. The duplex mode information may include an information element in a measurement report to indicate a duplex mode and/or operation mode (e.g., Mode 1-4, OpMode 1-4). The network server may also be configured to determine the duplex mode information based on reference signal identification information included in measurement reports received from the wireless node. For example, the measurement values may be based on PRS resources in a positioning frequency layer (PFL) such that each measurement value may be associated with a PRS ID value. The network server may be configured to correlate the PRS ID value with slot configuration information to determine which type of duplex slots a Rx-Tx measurement utilized.

At stage 1506, the method includes selecting a subset of the plurality of positioning reference signal measurement values based at least in part on the duplex mode information. The network server is a means for selecting a subset of the plurality of PRS measurement values. In an example, the network server may be configured to utilize Rx-Tx measurement values between a UE and a BS based on predetermined duplex modes and/or operational modes (e.g., Modes 1-4, OpModes 1-4). Since measurements based on like modes will have similar delay errors, the network server may determine average measurements for a selected mode. The subset of the plurality of PRS measurement values based on one or more of the Modes 1-4 described in FIG. 11A, and/or the operational modes (OpModes 1-4) described in FIG. 11B. In an example, the selected mode may be based on a quantity of measurements obtained, the RSRP values associated with measurements in the different modes, or other priority factors. A low latency application may utilize the earliest measurement mode. The duplex modes may be prioritized such that Mode 1 based measurements may be preferred to Mode 2 based measurements, which may be preferred to Mode 3 based measurements, which are preferred over Mode 4 based measurements. Other priorities may also be determined based on the duplex modes and/or other signal parameters and dilution of precision procedures.

At stage 1508, the method includes determining a position estimate for the wireless node based at least in part on the subset of the plurality of positioning reference signal measurement values. The network server is a means for determining a position estimate. In an example, referring to FIG. 6, the network server may be configured to determine a range between a UE and a BS based on the Rx-Tx measurements received from the UE, and RTT measurements provided by the BS. Constraining the PRS measurements to like duplex modes for a RTT measurement may mitigate the group errors and improve the range accuracy. Improved range accuracy across multiple RTT exchanges with other BSs may increase the overall accuracy of the position estimate.

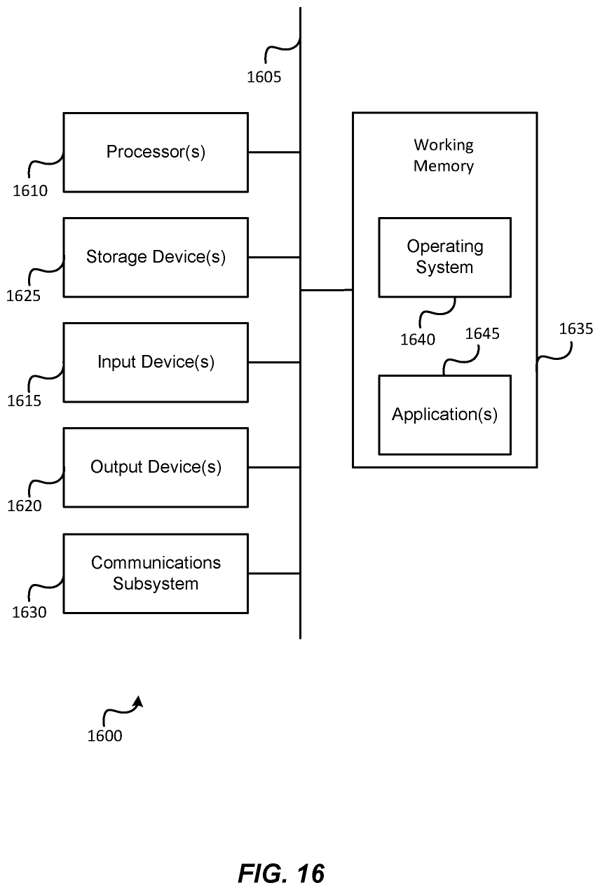

A computer system as illustrated in FIG. 16 may incorporate as part of the previously described computerized devices such as the BSs 110, UEs 120, and network controller 130. A computer system 1600 may be configured to perform the methods provided by various other embodiments, as described herein, and/or can function as a networked server, a mobile device, and/or a computer system. It should be noted that FIG. 16 is meant to provide a generalized illustration of various components, any or all of which may be utilized as appropriate. FIG. 16, therefore, broadly illustrates how individual system elements may be implemented in a relatively separated or relatively more integrated manner. The computer system 1600 is shown comprising hardware elements that can be electrically coupled via a bus 1605 (or may otherwise be in communication, as appropriate). The hardware elements may include one or more processors 1610, including without limitation one or more general-purpose processors and/or one or more special-purpose processors (such as digital signal processing chips, graphics acceleration processors, and/or the like); one or more input devices 1615, which can include without limitation a mouse, a keyboard and/or the like; and one or more output devices 1620, which can include without limitation a display device, a printer and/or the like.

The computer system 1600 may further include (and/or be in communication with) one or more non-transitory storage devices 1625, which can comprise, without limitation, local and/or network accessible storage, and/or can include, without limitation, a disk drive, a drive array, an optical storage device, solid-state storage devices such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1600 might also include a communications subsystem 1630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1630 may permit data to be exchanged with a network, other computer systems, and/or any other devices described herein. In many embodiments, the computer system 1600 will further comprise a working memory 1635, which can include a RAM or ROM device, as described above.

The computer system 1600 also can comprise software elements, shown as being currently located within the working memory 1635, including an operating system 1640, device drivers, executable libraries, and/or other code, such as one or more application programs 1645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1625 described above. In some cases, the storage medium might be incorporated within a computer system, such as the computer system 1600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1600 and/or might take the form of source and/or installable code, which, upon compilation and/or installation on the computer system 1600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1600) to perform methods in accordance with various embodiments of the disclosure. According to a set of embodiments, some or all of the procedures of such methods are performed by the computer system 1600 in response to processor 1610 executing one or more sequences of one or more instructions (which might be incorporated into the operating system 1640 and/or other code, such as an application program 1645) contained in the working memory 1635. Such instructions may be read into the working memory 1635 from another computer-readable medium, such as one or more of the storage device(s) 1625. Merely by way of example, execution of the sequences of instructions contained in the working memory 1635 might cause the processor(s) 1610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1600, various computer-readable media might be involved in providing instructions/code to processor(s) 1610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1625. Volatile media include, without limitation, dynamic memory, such as the working memory 1635. Transmission media include, without limitation, coaxial cables, copper wire and fiber optics, including the wires that comprise the bus 1605, as well as the various components of the communications subsystem 1630 (and/or the media by which the communications subsystem 1630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1600. These signals, which might be in the form of electromagnetic signals, acoustic signals, optical signals and/or the like, are all examples of carrier waves on which instructions can be encoded, in accordance with various embodiments of the disclosure.

The communications subsystem 1630 (and/or components thereof) generally will receive the signals, and the bus 1605 then might carry the signals (and/or the data, instructions, etc. carried by the signals) to the working memory 1635, from which the processor(s) 1605 retrieves and executes the instructions. The instructions received by the working memory 1635 may optionally be stored on a storage device 1625 either before or after execution by the processor(s) 1610.

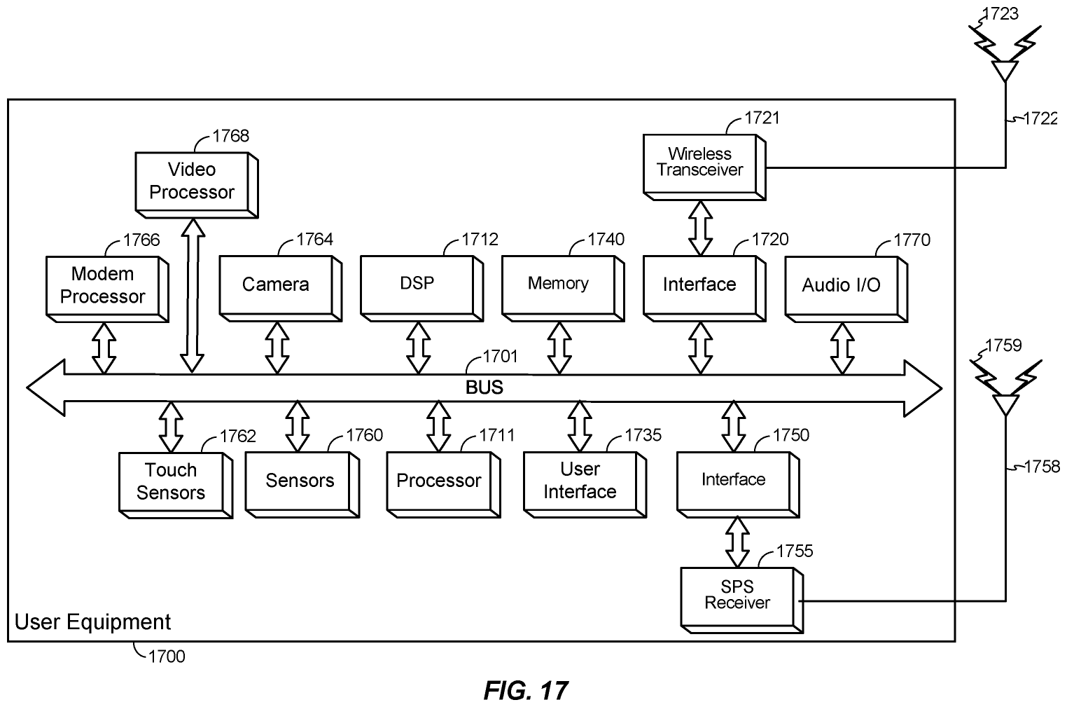

Referring to FIG. 17, a schematic diagram of a mobile device 1700 according to an embodiment is shown. The UE 120 as shown in FIG. 1 may comprise one or more features of the mobile device 1700 shown in FIG. 17. In certain embodiments, the mobile device 1700 may comprise a wireless transceiver 1721 which is capable of transmitting and receiving wireless signals 1723 via a wireless antenna 1722 over a wireless communication network. The wireless transceiver 1721 and the wireless antenna 1722 may include a plurality of transceivers and antennas, and may be configured for full duplex operation. A wireless transceiver 1721 may be connected to a bus 1701 by a wireless transceiver bus interface 1720. The wireless transceiver bus interface 1720 may, in some embodiments, be at least partially integrated with the wireless transceiver 1721. Some embodiments may include multiple wireless transceivers 1721 and wireless antennas 1722 to enable transmitting and/or receiving signals in full or half duplex modes according to corresponding multiple wireless communication standards such as, for example, versions of IEEE Standard 802.11, CDMA, WCDMA, LTE, UMTS, GSM, AMPS, Zigbee, Bluetooth®, and a 5G or NR radio interface defined by 3GPP, just to name a few examples. In a particular implementation, the wireless transceiver 1721 may receive and acquire a downlink signal comprising a terrestrial positioning signal such as a DL PRS, and transmit reference signals such as UL SRS. For example, the wireless transceiver 1721 may process an acquired terrestrial positioning signal sufficiently to enable detection of timing of the acquired terrestrial positioning signal.

The mobile device 1700 may comprise an SPS receiver 1755 capable of receiving and acquiring SPS signals 1759 via an SPS antenna 1758 (which may be the same as the antenna 1722 in some embodiments). The SPS receiver 1755 may process, in whole or in part, the acquired SPS signals 1759 for estimating a location of the mobile device 1700. One or more general-purpose processor(s) 1711, a memory 1740, one or more digital signal processor(s) (DSP(s)) 1712, an interface 1750, and/or specialized processors (not shown) may be utilized to process acquired SPS signals, in whole or in part, and/or to calculate an estimated location of the mobile device 1700, in conjunction with the SPS receiver 1755. Storage of SPS, TPS or other signals (e.g., signals acquired from the wireless transceiver 1721) or storage of measurements of these signals for use in performing positioning operations may be performed in the memory 1740 or registers (not shown). The general-purpose processor(s) 1711, the memory 1740, the DSP(s) 1712, and/or specialized processors may provide or support a location engine for use in processing measurements to estimate a location of the mobile device 1700. For example, the general-purpose processor(s) 1711 or the DSP(s) 1712 may process a downlink signal acquired by the wireless transceiver 1721 to, for example, make measurements of RSSI, Rx-Tx, RTT, AOA, TOA, RSTD, RSRP and/or RSRQ.

Also shown in FIG. 17, the DSP(s) 1712 and the general-purpose processor(s) 1711 may be connected to the memory 1740 through bus the 1701. A particular bus interface (not shown) may be integrated with the DSP(s) 1712, the general-purpose processor(s) 1711, and the memory 1740. In various embodiments, functions may be performed in response to execution of one or more machine-readable instructions stored in the memory 1740 such as on a computer-readable storage medium, such as RAM, ROM, FLASH, or disc drive, just to name a few examples. The one or more instructions may be executable by the general-purpose processor(s) 1711, specialized processors, or the DSP(s) 1712. The memory 1740 may comprise a non-transitory, processor-readable memory and/or a computer-readable memory that stores software code (programming code, instructions, etc.) that are executable by the processor(s) 1711 and/or the DSP(s) 1712 to perform functions described herein.

Also shown in FIG. 17, a user interface 1735 may comprise any one of several devices such as, for example, a speaker, microphone, display device, vibration device, keyboard, touch screen, just to name a few examples. In a particular implementation, the user interface 1735 may enable a user to interact with one or more applications hosted on the mobile device 1700. For example, devices of the user interface 1735 may store analog and/or digital signals on the memory 1740 to be further processed by the DSP(s) 1712 or the general purpose processor 1711 in response to action from a user. Similarly, applications hosted on the mobile device 1700 may store analog or digital signals on the memory 1740 to present an output signal to a user. The mobile device 1700 may optionally include a dedicated audio input/output (I/O) device 1770 comprising, for example, a dedicated speaker, microphone, digital to analog circuitry, analog to digital circuitry, amplifiers and/or gain control. This is merely an example of how an audio I/O may be implemented in a mobile device, and claimed subject matter is not limited in this respect. The mobile device 1700 may comprise touch sensors 1762 responsive to touching or pressure on a keyboard or touch screen device.

The mobile device 1700 may comprise a dedicated camera device 1764 for capturing still or moving imagery. The camera device 1764 may comprise, for example, an imaging sensor (e.g., charge coupled device or CMOS imager), lens, analog-to-digital circuitry, frame buffers, just to name a few examples. Additional processing, conditioning, encoding, and/or compression of signals representing captured images may be performed at the general purpose/application processor 1711 and/or the DSP(s) 1712. A dedicated video processor 1768 may perform conditioning, encoding, compression or manipulation of signals representing captured images. A video processor 1768 may decode/decompress stored image data for presentation on a display device (not shown) on the mobile device 1700.

The mobile device 1700 may also comprise sensors 1760 coupled to the bus 1701 which may include, for example, inertial sensors and environment sensors. Inertial sensors of the sensors 1760 may comprise, for example, accelerometers (e.g., collectively responding to acceleration of the mobile device 1700 in three dimensions), one or more gyroscopes or one or more magnetometers (e.g., to support one or more compass applications). Environment sensors of the mobile device 1700 may comprise, for example, temperature sensors, barometric pressure sensors, ambient light sensors, camera imagers, microphones, just to name few examples. The sensors 1760 may generate analog and/or digital signals that may be stored in the memory 1740 and processed by the DPS(s) 1712 or the general purpose/application processor 1711 in support of one or more applications such as, for example, applications directed to positioning or navigation operations.

The mobile device 1700 may comprise a dedicated modem processor 1766 capable of performing baseband processing of signals received and downconverted at the wireless transceiver 1721 or the SPS receiver 1755. The modem processor 1766 may perform baseband processing of signals to be upconverted for transmission by the wireless transceiver 1721. In alternative implementations, instead of having a dedicated modem processor, baseband processing may be performed by a general purpose processor or DSP (e.g., the general purpose/application processor 1711 or the DSP(s) 1712). These are merely examples of structures that may perform baseband processing, and claimed subject matter is not limited in this respect.

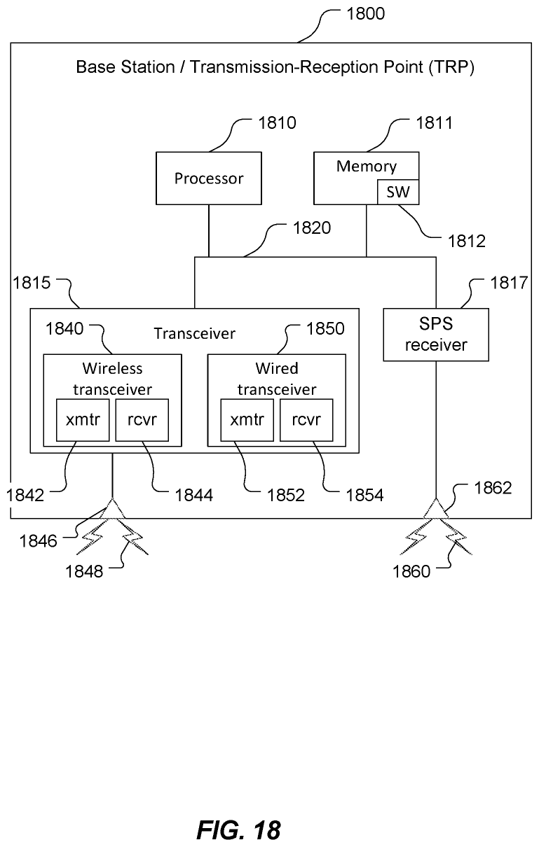

Referring also to FIG. 18, an example of a TRP 1800 of the BSs 110 comprises a computing platform including a processor 1810, memory 1811 including software (SW) 1812, a transceiver 1815, and (optionally) an SPS receiver 1817. The processor 1810, the memory 1811, the transceiver 1815, and the SPS receiver 1817 may be communicatively coupled to each other by a bus 1820 (which may be configured, e.g., for optical and/or electrical communication). One or more of the shown apparatus (e.g., a wireless interface and/or the SPS receiver 1817) may be omitted from the TRP 1800. The SPS receiver 1817 may be configured similarly to the SPS receiver 1755 to be capable of receiving and acquiring SPS signals 1860 via an SPS antenna 1862. The processor 1810 may include one or more intelligent hardware devices, e.g., a central processing unit (CPU), a microcontroller, an application specific integrated circuit (ASIC), etc. The processor 1810 may comprise multiple processors (e.g., including a general-purpose/application processor, a DSP, a modem processor, a video processor, and/or a sensor processor). The memory 1811 is a non-transitory storage medium that may include random access memory (RAM)), flash memory, disc memory, and/or read-only memory (ROM), etc. The memory 1811 stores the software 1812 which may be processor-readable, processor-executable software code containing instructions that are configured to, when executed, cause the processor 1810 to perform various functions described herein. Alternatively, the software 1812 may not be directly executable by the processor 1810 but may be configured to cause the processor 1810, e.g., when compiled and executed, to perform the functions. The description may refer to the processor 1810 performing a function, but this includes other implementations such as where the processor 1810 executes software and/or firmware. The description may refer to the processor 1810 performing a function as shorthand for one or more of the processors contained in the processor 1810 performing the function. The description may refer to the TRP 1800 performing a function as shorthand for one or more appropriate components of the TRP 1800 (and thus of one of the BSs 110) performing the function. The processor 1810 may include a memory with stored instructions in addition to and/or instead of the memory 1811. Functionality of the processor 1810 is discussed more fully below.

The transceiver 1815 may include a wireless transceiver 1840 and a wired transceiver 1850 configured to communicate with other devices through wireless connections and wired connections, respectively. For example, the wireless transceiver 1840 may include a transmitter 1842 and receiver 1844 coupled to one or more antennas 1846 for transmitting (e.g., on one or more uplink channels) and/or receiving (e.g., on one or more downlink channels) wireless signals 1848 and transducing signals from the wireless signals 1848 to wired (e.g., electrical and/or optical) signals and from wired (e.g., electrical and/or optical) signals to the wireless signals 1848. Thus, the transmitter 1842 may include multiple transmitters that may be discrete components or combined/integrated components, and/or the receiver 1844 may include multiple receivers that may be discrete components or combined/integrated components. The wireless transceiver 1840 may be configured to communicate signals (e.g., with the UE 120, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 1850 may include a transmitter 1852 and a receiver 1854 configured for wired communication, e.g., with the network controller 130 to send communications to, and receive communications from, the network controller 130, for example. The transmitter 1852 may include multiple transmitters that may be discrete components or combined/integrated components, and/or the receiver 1854 may include multiple receivers that may be discrete components or combined/integrated components. The wired transceiver 1850 may be configured, e.g., for optical communication and/or electrical communication.

The configuration of the TRP 1800 shown in FIG. 18 is an example and not limiting of the disclosure, including the claims, and other configurations may be used. For example, the description herein discusses that the TRP 1800 is configured to perform or performs several functions, but one or more of these functions may be performed by the computer system 1600 and/or the UE 120 (i.e., the UE 120 may be configured to perform one or more of these functions).

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

Implementation examples are described in the following numbered clauses:

Clause 1. A method for providing positioning reference signal measurement values, comprising: receiving assistance data including configuration information for downlink and uplink positioning reference signals; determining timing information for the downlink and the uplink positioning reference signals relative to a first period associated with a half duplex mode and a second period associated with a full duplex mode; performing a round trip time message exchange with a wireless node in either the first period or the second period, wherein a downlink positioning reference signal is received and an uplink positioning reference signal is transmitted during a selected period; and reporting one or more positioning reference signal measurement values and an indication of an associated duplex mode.

Clause 2. The method of clause 1 wherein the assistance data is received via one or more long term evolution positioning protocol (LPP) messages.

Clause 3. The method of clause 1 wherein the assistance data is received via one or more radio resource control (RRC) messages.

Clause 4. The method of clause 1 wherein the downlink and the uplink positioning reference signals are associated with a positioning frequency layer.

Clause 5. The method of clause 1 wherein the assistance data includes timing information for half duplex and full duplex operations.

Clause 6. The method of clause 1 wherein the one or more positioning reference signal measurement values includes a receive-transmit time difference measurement value indicating a receive time for the received downlink positioning reference signal and a transmit time for the transmitted uplink positioning reference signal.

Clause 7. The method of clause 1 wherein the one or more positioning reference signal measurement values includes a reference signal received power measurement value for the received downlink positioning reference signal.

Clause 8. The method of clause 1 wherein reporting the one or more positioning reference signal measurement values includes reporting a batch of positioning reference signal measurement values and the indication of the associated duplex mode for each positioning reference signal measurement value in the batch of positioning reference signal measurement values.

Clause 9. A method of performing a round trip time message exchange, comprising: performing the round trip time message exchange with a wireless node including receiving a downlink positioning reference signal and transmitting an uplink positioning reference signal, wherein the round trip time message exchange is associated with at least one duplex mode; and reporting a receive-transmit time difference measurement value based on the round trip time message exchange, wherein the reporting includes an indication of the at least one duplex mode.

Clause 10. The method of clause 9 wherein the indication of the at least one duplex mode indicates the downlink positioning reference signal is received in a half duplex slot and the uplink positioning reference signal is transmitted in a half duplex slot.

Clause 11. The method of clause 9 wherein the indication of the at least one duplex mode indicates the downlink positioning reference signal is received in a full duplex slot and the uplink positioning reference signal is transmitted in a full duplex slot.

Clause 12. The method of clause 9 wherein the indication of the at least one duplex mode indicates the downlink positioning reference signal is received in a full duplex slot and the uplink positioning reference signal is transmitted in a half duplex slot.

Clause 13. The method of clause 9 wherein the indication of the at least one duplex mode indicates the downlink positioning reference signal is received in a half duplex slot and the uplink positioning reference signal is transmitted in a full duplex slot.

Clause 14. The method of clause 9 wherein the indication of the at least one duplex mode indicates the downlink positioning reference signal is received while in a half duplex operational mode and the uplink positioning reference signal is transmitted while in the half duplex operational mode.

Clause 15. The method of clause 9 wherein the indication of the at least one duplex mode indicates the downlink positioning reference signal is received while in a full duplex operational mode and the uplink positioning reference signal is transmitted while in the full duplex operational mode.

Clause 16. The method of clause 9 wherein the indication of the at least one duplex mode indicates the downlink positioning reference signal is received while in a half duplex operational mode and the uplink positioning reference signal is transmitted while in a full duplex operational mode.

Clause 17. The method of clause 9 wherein the indication of the at least one duplex mode indicates the downlink positioning reference signal is received while in a full duplex operational mode and the uplink positioning reference signal is transmitted while in the full duplex operational mode.

Clause 18. The method of clause 9 further comprising providing an on-demand request for the round trip time message exchange, wherein the on-demand request includes the indication of the at least one duplex mode.

Clause 19. A method of determining a position estimate of a wireless node, comprising: receiving a plurality of positioning reference signal measurement values from the wireless node; determining duplex mode information associated with each of the plurality of positioning reference signal measurement values; selecting a subset of the plurality of positioning reference signal measurement values based at least in part on the duplex mode information; and determining the position estimate for the wireless node based at least in part on the subset of the plurality of positioning reference signal measurement values.

Clause 20. The method of clause 19 wherein selecting the subset of the plurality of positioning reference signal measurement values includes selecting one or more receive-transmit time difference measurement values based a downlink positioning reference signal received in a half duplex slot and an uplink positioning reference signal transmitted in a half duplex slot.

Clause 21. The method of clause 19 wherein selecting the subset of the plurality of positioning reference signal measurement values includes selecting one or more receive-transmit time difference measurement values based a downlink positioning reference signal received in a full duplex slot and an uplink positioning reference signal transmitted in a full duplex slot.

Clause 22. The method of clause 19 wherein selecting the subset of the plurality of positioning reference signal measurement values includes selecting one or more receive-transmit time difference measurement values based a downlink positioning reference signal received in a half duplex slot and an uplink positioning reference signal transmitted in a full duplex slot.

Clause 23. The method of clause 19 wherein selecting the subset of the plurality of positioning reference signal measurement values includes selecting one or more receive-transmit time difference measurement values based a downlink positioning reference signal received in a full duplex slot and an uplink positioning reference signal transmitted in a half duplex slot.

Clause 24. The method of clause 19 wherein selecting the subset of the plurality of positioning reference signal measurement values includes selecting one or more receive-transmit time difference measurement values based a downlink positioning reference signal received when the wireless node was in a half duplex operational mode and an uplink positioning reference signal transmitted when the wireless node was in the half duplex operational mode.

Clause 25. The method of clause 19 wherein selecting the subset of the plurality of positioning reference signal measurement values includes selecting one or more receive-transmit time difference measurement values based a downlink positioning reference signal received when the wireless node was in a full duplex operational mode and an uplink positioning reference signal transmitted when the wireless node was in the full duplex operational mode.

Clause 26. The method of clause 19 wherein selecting the subset of the plurality of positioning reference signal measurement values includes selecting one or more receive-transmit time difference measurement values based a downlink positioning reference signal received when the wireless node was in a half duplex operational mode and an uplink positioning reference signal transmitted when the wireless node was in a full duplex operational mode.

Clause 27. The method of clause 19 wherein selecting the subset of the plurality of positioning reference signal measurement values includes selecting one or more receive-transmit time difference measurement values based a downlink positioning reference signal received when the wireless node was in a full duplex operational mode and an uplink positioning reference signal transmitted when the wireless node was in a half duplex operational mode.

Clause 28. The method of clause 19 wherein the plurality of positioning reference signal measurement values are included in a batch measurement report provided by the wireless node.

Clause 29. The method of clause 28 wherein the batch measurement report includes duplex mode information for each of the plurality of positioning reference signal measurement values.

Clause 30. An apparatus, comprising: a memory; at least one transceiver; at least one processor communicatively coupled to the memory and the at least one transceiver, and configured to: receive assistance data including configuration information for downlink and uplink positioning reference signals; determine timing information for the downlink and the uplink positioning reference signals relative to a first period associated with a half duplex mode and a second period associated with a full duplex mode; perform a round trip time message exchange with a wireless node in either the first period or the second period, wherein a downlink positioning reference signal is received and an uplink positioning reference signal is transmitted during a selected period; and report one or more positioning reference signal measurement values and an indication of an associated duplex mode.

Clause 31. The apparatus of clause 30 wherein the at least one processor is further configured to receive the assistance data via one or more long term evolution positioning protocol (LPP) messages.

Clause 32. The apparatus of clause 30 wherein the at least one processor is further configured to receive that assistance data via one or more radio resource control (RRC) messages.

Clause 33. The apparatus of clause 30 wherein the assistance data includes timing information for half duplex and full duplex operations.

Clause 34. The apparatus of clause 30 wherein the one or more positioning reference signal measurement values includes a receive-transmit time difference measurement value indicating a receive time for the received downlink positioning reference signal and a transmit time for the transmitted uplink positioning reference signal.

Clause 35. The apparatus of clause 30 wherein the one or more positioning reference signal measurement values includes a reference signal received power measurement value for the received downlink positioning reference signal.

Clause 36. The apparatus of clause 30 wherein the at least one processor is further configured to report a batch of positioning reference signal measurement values and the indication of the associated duplex mode for each positioning reference signal measurement value in the batch of positioning reference signal measurement values.

Clause 37. An apparatus, comprising: a memory; at least one transceiver; at least one processor communicatively coupled to the memory and the at least one transceiver, and configured to: perform a round trip time message exchange with a wireless node including receiving a downlink positioning reference signal and transmitting an uplink positioning reference signal, wherein the round trip time message exchange is associated with at least one duplex mode; and report a receive-transmit time difference measurement value based on the round trip time message exchange, wherein the reporting includes an indication of the at least one duplex mode.

Clause 38. The apparatus of clause 37 wherein the indication of the at least one duplex mode indicates the downlink positioning reference signal is received in a half duplex slot and the uplink positioning reference signal is transmitted in a half duplex slot.

Clause 39. The apparatus of clause 37 wherein the indication of the at least one duplex mode indicates the downlink positioning reference signal is received in a full duplex slot and the uplink positioning reference signal is transmitted in a full duplex slot.

Clause 40. The apparatus of clause 37 wherein the indication of the at least one duplex mode indicates the downlink positioning reference signal is received in a full duplex slot and the uplink positioning reference signal is transmitted in a half duplex slot.

Clause 41. The apparatus of clause 37 wherein the indication of the at least one duplex mode indicates the downlink positioning reference signal is received in a half duplex slot and the uplink positioning reference signal is transmitted in a full duplex slot.

Clause 42. The apparatus of clause 37 wherein the indication of the at least one duplex mode indicates the downlink positioning reference signal is received while in a half duplex operational mode and the uplink positioning reference signal is transmitted while in the half duplex operational mode.

Clause 43. The apparatus of clause 37 wherein the indication of the at least one duplex mode indicates the downlink positioning reference signal is received while in a full duplex operational mode and the uplink positioning reference signal is transmitted while in the full duplex operational mode.

Clause 44. The apparatus of clause 37 wherein the indication of the at least one duplex mode indicates the downlink positioning reference signal is received while in a half duplex operational mode and the uplink positioning reference signal is transmitted while in a full duplex operational mode.

Clause 45. The apparatus of clause 37 wherein the indication of the at least one duplex mode indicates the downlink positioning reference signal is received while in a full duplex operational mode and the uplink positioning reference signal is transmitted while in the full duplex operational mode.

Clause 46. The apparatus of clause 37 wherein the at least one processor is further configured to provide an on-demand request for the round trip time message exchange, wherein the on-demand request includes the indication of the at least one duplex mode.

Clause 47. An apparatus, comprising: a memory; at least one transceiver; at least one processor communicatively coupled to the memory and the at least one transceiver, and configured to: receive a plurality of positioning reference signal measurement values from a wireless node; determine duplex mode information associated with each of the plurality of positioning reference signal measurement values; select a subset of the plurality of positioning reference signal measurement values based at least in part on the duplex mode information; and determine a position estimate for the wireless node based at least in part on the subset of the plurality of positioning reference signal measurement values.

Clause 48. The apparatus of clause 47 wherein the at least one processor is further configured to select one or more receive-transmit time difference measurement values based a downlink positioning reference signal received in a half duplex slot and an uplink positioning reference signal transmitted in a half duplex slot.

Clause 49. The apparatus of clause 47 wherein the at least one processor is further configured to select one or more receive-transmit time difference measurement values based a downlink positioning reference signal received in a full duplex slot and an uplink positioning reference signal transmitted in a full duplex slot.

Clause 50. The apparatus of clause 47 wherein the at least one processor is further configured to select one or more receive-transmit time difference measurement values based a downlink positioning reference signal received in a half duplex slot and an uplink positioning reference signal transmitted in a full duplex slot.

Clause 51. The apparatus of clause 47 wherein the at least one processor is further configured to select one or more receive-transmit time difference measurement values based a downlink positioning reference signal received in a full duplex slot and an uplink positioning reference signal transmitted in a half duplex slot.

Clause 52. The apparatus of clause 47 wherein the at least one processor is further configured to select one or more receive-transmit time difference measurement values based a downlink positioning reference signal received when the wireless node was in a half duplex operational mode and an uplink positioning reference signal transmitted when the wireless node was in the half duplex operational mode.

Clause 53. The apparatus of clause 47 wherein the at least one processor is further configured to select one or more receive-transmit time difference measurement values based a downlink positioning reference signal received when the wireless node was in a full duplex operational mode and an uplink positioning reference signal transmitted when the wireless node was in the full duplex operational mode.

Clause 54. The apparatus of clause 47 wherein the at least one processor is further configured to select one or more receive-transmit time difference measurement values based a downlink positioning reference signal received when the wireless node was in a half duplex operational mode and an uplink positioning reference signal transmitted when the wireless node was in a full duplex operational mode.

Clause 55. The apparatus of clause 47 wherein the at least one processor is further configured to select one or more receive-transmit time difference measurement values based a downlink positioning reference signal received when the wireless node was in a full duplex operational mode and an uplink positioning reference signal transmitted when the wireless node was in a half duplex operational mode.

Clause 56. The apparatus of clause 47 wherein the plurality of positioning reference signal measurement values are included in a batch measurement report provided by the wireless node.

Clause 57. The apparatus of clause 56 wherein the batch measurement report includes duplex mode information for each of the plurality of positioning reference signal measurement values.

Clause 58. An apparatus for providing positioning reference signal measurement values, comprising: means for receiving assistance data including configuration information for downlink and uplink positioning reference signals; means for determining timing information for the downlink and the uplink positioning reference signals relative to a first period associated with a half duplex mode and a second period associated with a full duplex mode; means for performing a round trip time message exchange with a wireless node in either the first period or the second period, wherein a downlink positioning reference signal is received and an uplink positioning reference signal is transmitted during a selected period; and means for reporting one or more positioning reference signal measurement values and an indication of an associated duplex mode.

Clause 59. An apparatus for performing a round trip time message exchange, comprising: means for performing the round trip time message exchange with a wireless node including receiving a downlink positioning reference signal and transmitting an uplink positioning reference signal, wherein the round trip time message exchange is associated with at least one duplex mode; and means for reporting a receive-transmit time difference measurement value based on the round trip time message exchange, wherein the reporting includes an indication of the at least one duplex mode.

Clause 60. An apparatus for determining a position estimate of a wireless node, comprising: means for receiving a plurality of positioning reference signal measurement values from the wireless node; means for determining duplex mode information associated with each of the plurality of positioning reference signal measurement values; means for selecting a subset of the plurality of positioning reference signal measurement values based at least in part on the duplex mode information; and means for determining the position estimate for the wireless node based at least in part on the subset of the plurality of positioning reference signal measurement values.

Clause 61. A non-transitory processor-readable storage medium comprising processor-readable instructions configured to cause one or more processors to provide positioning reference signal measurement values, comprising code for: receiving assistance data including configuration information for downlink and uplink positioning reference signals; determining timing information for the downlink and the uplink positioning reference signals relative to a first period associated with a half duplex mode and a second period associated with a full duplex mode; performing a round trip time message exchange with a wireless node in either the first period or the second period, wherein a downlink positioning reference signal is received and an uplink positioning reference signal is transmitted during a selected period; and reporting one or more positioning reference signal measurement values and an indication of an associated duplex mode.

Clause 62. A non-transitory processor-readable storage medium comprising processor-readable instructions configured to cause one or more processors to perform a round trip time message exchange, comprising code for: performing the round trip time message exchange with a wireless node including receiving a downlink positioning reference signal and transmitting an uplink positioning reference signal, wherein the round trip time message exchange is associated with at least one duplex mode; and reporting a receive-transmit time difference measurement value based on the round trip time message exchange, wherein the reporting includes an indication of the at least one duplex mode.

Clause 63. A non-transitory processor-readable storage medium comprising processor-readable instructions configured to cause one or more processors to determine a position estimate of a wireless node, comprising code for: receiving a plurality of positioning reference signal measurement values from the wireless node; determining duplex mode information associated with each of the plurality of positioning reference signal measurement values; selecting a subset of the plurality of positioning reference signal measurement values based at least in part on the duplex mode information; and determining the position estimate for the wireless node based at least in part on the subset of the plurality of positioning reference signal measurement values.

What is claimed is:

1. A method for providing positioning reference signal measurement values, comprising:
receiving assistance data including configuration information for downlink and uplink positioning reference signals;
determining timing information for the downlink and the uplink positioning reference signals relative to a first period associated with a half duplex mode and a second period associated with a full duplex mode;
performing a round trip time message exchange with a wireless node in either the first period or the second period, wherein a downlink positioning reference signal is received and an uplink positioning reference signal is transmitted during a selected period; and
reporting one or more positioning reference signal measurement values and an indication of an associated duplex mode.

2. The method of claim 1 wherein the assistance data is received via one or more long term evolution positioning protocol (LPP) messages.

3. The method of claim 1 wherein the assistance data is received via one or more radio resource control (RRC) messages.

4. The method of claim 1 wherein the assistance data includes timing information for half duplex and full duplex operations.

5. The method of claim 1 wherein the one or more positioning reference signal measurement values includes a receive-transmit time difference measurement value indicating a receive time for the received downlink positioning reference signal and a transmit time for the transmitted uplink positioning reference signal.

6. The method of claim 1 wherein the one or more positioning reference signal measurement values includes a reference signal received power measurement value for the received downlink positioning reference signal.

7. The method of claim 1 wherein reporting the one or more positioning reference signal measurement values includes reporting a batch of positioning reference signal measurement values and the indication of the associated duplex mode for each positioning reference signal measurement value in the batch of positioning reference signal measurement values.

8. A method of determining a position estimate of a wireless node, comprising:
receiving a plurality of positioning reference signal measurement values from the wireless node;
determining duplex mode information associated with each of the plurality of positioning reference signal measurement values;
selecting a subset of the plurality of positioning reference signal measurement values based at least in part on the duplex mode information; and
determining the position estimate for the wireless node based at least in part on the subset of the plurality of positioning reference signal measurement values.

9. The method of claim 8 wherein selecting the subset of the plurality of positioning reference signal measurement values includes selecting one or more receive-transmit time difference measurement values based a downlink positioning reference signal received in a half duplex slot and an uplink positioning reference signal transmitted in a half duplex slot.

10. The method of claim 8 wherein selecting the subset of the plurality of positioning reference signal measurement values includes selecting one or more receive-transmit time difference measurement values based a downlink positioning reference signal received in a full duplex slot and an uplink positioning reference signal transmitted in a full duplex slot.

11. The method of claim 8 wherein selecting the subset of the plurality of positioning reference signal measurement values includes selecting one or more receive-transmit time difference measurement values based a downlink positioning reference signal received in a half duplex slot and an uplink positioning reference signal transmitted in a full duplex slot.

12. The method of claim 8 wherein selecting the subset of the plurality of positioning reference signal measurement values includes selecting one or more receive-transmit time difference measurement values based a downlink positioning reference signal received in a full duplex slot and an uplink positioning reference signal transmitted in a half duplex slot.

13. The method of claim 8 wherein selecting the subset of the plurality of positioning reference signal measurement values includes selecting one or more receive-transmit time difference measurement values based a downlink positioning reference signal received when the wireless node was in a half duplex operational mode and an uplink positioning reference signal transmitted when the wireless node was in the half duplex operational mode.

14. The method of claim 8 wherein selecting the subset of the plurality of positioning reference signal measurement values includes selecting one or more receive-transmit time difference measurement values based a downlink positioning reference signal received when the wireless node was in a full duplex operational mode and an uplink positioning reference signal transmitted when the wireless node was in the full duplex operational mode.

15. The method of claim 8 wherein selecting the subset of the plurality of positioning reference signal measurement values includes selecting one or more receive-transmit time difference measurement values based a downlink positioning reference signal received when the wireless node was in a half duplex operational mode and an uplink positioning reference signal transmitted when the wireless node was in a full duplex operational mode.

16. The method of claim 8 wherein selecting the subset of the plurality of positioning reference signal measurement values includes selecting one or more receive-transmit time difference measurement values based a downlink positioning reference signal received when the wireless node was in a full duplex operational mode and an uplink positioning reference signal transmitted when the wireless node was in a half duplex operational mode.

17. The method of claim 8 wherein the plurality of positioning reference signal measurement values are included in a batch measurement report provided by the wireless node.

18. The method of claim 17 wherein the batch measurement report includes the duplex mode information associated with each of the plurality of positioning reference signal measurement values.

19. An apparatus, comprising:
a memory;
at least one transceiver;
at least one processor communicatively coupled to the memory and the at least one transceiver, and configured to:
receive assistance data including configuration information for downlink and uplink positioning reference signals;
determine timing information for the downlink and the uplink positioning reference signals relative to a first period associated with a half duplex mode and a second period associated with a full duplex mode;
perform a round trip time message exchange with a wireless node in either the first period or the second period, wherein a downlink positioning reference signal is received and an uplink positioning reference signal is transmitted during a selected period; and
report one or more positioning reference signal measurement values and an indication of an associated duplex mode.

20. The apparatus of claim 19 wherein the at least one processor is further configured to report a batch of positioning reference signal measurement values and the indication of the associated duplex mode for each positioning reference signal measurement value in the batch of positioning reference signal measurement values.

21. A method of performing a round trip time message exchange, comprising:
performing the round trip time message exchange with a wireless node including receiving a downlink positioning reference signal and transmitting an uplink positioning reference signal, wherein the round trip time message exchange is associated with at least one duplex mode; and
reporting a receive-transmit time difference measurement value based on the round trip time message exchange, wherein the reporting includes an indication of the at least one duplex mode.

22. The method of claim 21 wherein the indication of the at least one duplex mode indicates the downlink positioning reference signal is received in a half duplex slot and the uplink positioning reference signal is transmitted in a half duplex slot.

23. The method of claim 21 wherein the indication of the at least one duplex mode indicates the downlink positioning reference signal is received in a full duplex slot and the uplink positioning reference signal is transmitted in a full duplex slot.

24. The method of claim 21 wherein the indication of the at least one duplex mode indicates the downlink positioning reference signal is received in a full duplex slot and the uplink positioning reference signal is transmitted in a half duplex slot.

25. The method of claim 21 wherein the indication of the at least one duplex mode indicates the downlink positioning reference signal is received in a half duplex slot and the uplink positioning reference signal is transmitted in a full duplex slot.

26. The method of claim 21 wherein the indication of the at least one duplex mode indicates the downlink positioning reference signal is received while in a half duplex operational mode and the uplink positioning reference signal is transmitted while in the half duplex operational mode.

27. The method of claim 21 wherein the indication of the at least one duplex mode indicates the downlink positioning reference signal is received while in a full duplex operational mode and the uplink positioning reference signal is transmitted while in the full duplex operational mode.

28. The method of claim 21 wherein the indication of the at least one duplex mode indicates the downlink positioning reference signal is received while in a half duplex operational mode and the uplink positioning reference signal is transmitted while in a full duplex operational mode.

29. The method of claim 21 wherein the indication of the at least one duplex mode indicates the downlink positioning reference signal is received while in a full duplex operational mode and the uplink positioning reference signal is transmitted while in the full duplex operational mode.

30. The method of claim 21 further comprising providing an on-demand request for the round trip time message exchange, wherein the on-demand request includes the indication of the at least one duplex mode.
